(19) United States
(12) Patent Application Publication
(10) Pub. No.: US 2024/0121061 A1
(43) Pub. Date: Apr. 11, 2024

(54) INFORMATION TRANSMISSION METHOD, TERMINAL DEVICE, BASE STATION, AND STORAGE MEDIUM

(71) Applicant: Beijing Xiaomi Mobile Software Co., Ltd., Beijing (CN)

(72) Inventor: Yang LIU, Beijing (CN)

(21) Appl. No.: 18/553,097

(22) PCT Filed: Apr. 1, 2021
(86) PCT No.: PCT/CN21/84932

§ 371 Date: Sep. 28, 2023

(51) Int. Cl. H04L 5/00; H04W 72/1268; H04W 72/232; H04W 72/51

(52) U.S. Cl. CPC H04L 5/0051; H04W 72/1268; H04W 72/232; H04W 72/51

(57) ABSTRACT

The present disclosure relates to the technical field of communications, and provides a method, apparatus, terminal device, base station, and storage medium for transmitting information. The method comprises: obtaining a target demodulation reference signal (DMRS) port associated with uplink PT-RS transmission, wherein the target DMRS port configured by a base station is used for PT-RS transmission of a PUSCH at a first transmission occasion; determining a corresponding target DMRS port used for transmitting a PT-RS at each subsequent transmission occasion, wherein one PT-RS port corresponds to one target DMRS port at each transmission occasion, the target DMRS port is comprised in a DMRS port group associated with the corresponding PT-RS port, and target DMRS ports corresponding to two adjacent transmission occasions are different; and mapping a PT-RS port to a corresponding target DMRS port at each transmission occasion for the PT-RS transmission.

### BACKGROUND

Phase-tracking reference signals (PT-RS), as reference signals dedicated for user equipment (UE), are configured by a base station to the UE. In 5G new radio (NR), by introducing a PT-RS, a phase change caused by phase noise may be tracked, thus guaranteeing that the base station can perform phase noise estimation on links to compensate for the influence of the phase noise. In the related art, when the UE sends the PT-RS, a PT-RS port will be mapped into a demodulation reference signal (DMRS) port configured by the base station to achieve PT-RS transmission.

### SUMMARY

The disclosure provides a method, apparatus, terminal device, base station, and storage medium for transmitting information.

An example in one aspect of the disclosure provides a method, for transmitting information, performed by user equipment (UE), and including:
obtaining a target demodulation reference signal (DMRS) port associated with uplink transmission for phase-tracking reference signal (PT-RS), where the target DMRS port is used for PT-RS transmission at a first transmission occasion of a physical uplink shared channel (PUSCH);
determining a target DMRS port associated with each subsequent transmission occasion for a PT-RS transmission, where one PT-RS port corresponds to one target DMRS port at each transmission occasion, the target DMRS port is included in a DMRS port group associated with the corresponding PT-RS port, and target DMRS ports corresponding to two adjacent transmission occasions are different; and
mapping a PT-RS port to a corresponding target DMRS port at each transmission occasion for the PT-RS transmission.

An example in another aspect of the disclosure provides a method for transmitting information, performed by a base station, and including:
sending a target DMRS port associated with uplink transmission for phase-tracking reference signal (PT-RS) to UE, wherein the target DMRS port is used for PT-RS transmission of a PUSCH at a first transmission occasion.

An example in yet another aspect of the disclosure provides user equipment, including: a transceiver; a memory; and a processor, connected with the transceiver and the memory and configured to control wireless signal transceiving of the transceiver and implement the method provided by any example above by executing computer-executable instructions stored in the memory.

An example in yet another aspect of the disclosure provides a base station, including: a transceiver; a memory; and a processor, connected with the transceiver and the memory and configured to control wireless signal transceiving of the transceiver and implement the method provided by any example above by executing computer-executable instructions stored in the memory.

An example in yet another aspect of the disclosure provides a computer storage medium which stores computer-executable instructions. The computer-executable instructions can implement the method provided by any example above after being executed by a processor.

Additional aspects and advantages of the disclosure will be partially set forth in the description which follows, and a part will be apparent from the following description, or may be learned by practice of the disclosure.

### BRIEF DESCRIPTION OF THE DRAWINGS

The above and/or additional aspects and advantages of the disclosure will become apparent and understandable from the following description of the examples in conjunction with the accompanying drawings, where:

FIG. 1 is a schematic flow diagram of a method for transmitting information provided by an example of the disclosure.

FIG. 2 is a schematic flow diagram of a method for transmitting information provided by another example of the disclosure.

FIG. 3 is a schematic flow diagram of a method for transmitting information provided by another example of the disclosure.

FIG. 4 is a schematic flow diagram of a method for transmitting information provided by another example of the disclosure.

FIG. 5 is a schematic flow diagram of a method for transmitting information provided by another example of the disclosure.

FIG. 6 is a schematic flow diagram of a method for transmitting information provided by another example of the disclosure.

FIG. 7 is a schematic flow diagram of a method for transmitting information provided by another example of the disclosure.

FIG. 8 is a schematic flow diagram of a method for transmitting information provided by another example of the disclosure.

FIG. 9 is a schematic flow diagram of a method for transmitting information provided by another example of the disclosure.

FIG. 10 is a schematic flow diagram of a method for transmitting information provided by another example of the disclosure.

FIG. 11 is a schematic structural diagram of an apparatus for transmitting information provided by an example of the disclosure.

FIG. 12 is a schematic structural diagram of an apparatus for transmitting information provided by an example of the disclosure.

FIG. 13 is a block diagram of user equipment provided by an example of the disclosure.

FIG. 14 is a block diagram of a base station provided by an example of the disclosure.

### DETAILED DESCRIPTION

Examples will be described in detail here, and instances of the examples are shown in the accompanying drawings. When the following description refers to the accompanying drawings, unless otherwise indicated, the same numbers in different drawings indicate the same or similar elements. The implementations described in the following examples do not represent all implementations consistent with the examples of the disclosure. Rather, they are merely instances of apparatuses and methods consistent with some aspects of the examples of the disclosure as detailed in the appended claims.

The terms used in the examples of the disclosure are merely for the purpose of describing specific examples, and are not intended to limit the examples of the disclosure. The singular forms “one” and “the” used in the examples of the disclosure and the appended claims are also intended to include the majority forms unless the context clearly indicates other meanings. It should also be understood that the term “and/or” as used here refers to and contains any or all possible combinations of one or more associated listed items.

It should be understood that although the terms first, second, third, etc. may be used to describe various information in the examples of the disclosure, such information should not be limited to these terms. These terms are merely used to distinguish the same type of information from each other. For example, without departing from the scope of the examples of the disclosure, first information may also be referred to as second information, and similarly, the second information may also be referred to as the first information. Depending on the context, the word “if” and “in case” as used here may be interpreted as “at the time” or “when” or “in response to determining”.

The examples of the disclosure are described in detail below, and instances of the examples are shown in the accompanying drawings, where the same or similar reference numerals represent the same or similar elements throughout. The examples described below with reference to the accompanying drawings are exemplary and are intended to explain the disclosure, instead of being construed as limiting the disclosure.

In the related art, when the PT-RS is repeatedly transmitted, the DMRS port mapped by the PT-RS port on each transmission occasion is fixed. Since the channel quality of channels corresponding to DMRS ports at different transmission occasions will be different, it cannot ensure that the channel quality of a transmission channel of the PT-RS at each transmission occasion is the channel with the highest channel quality at the current transmission occasion, and thus the transmission precision of the PT-RS will be affected, resulting in inaccurate phase noise estimation.

The disclosure relates to the technical field of communications, in particular to method, apparatus, terminal device, base station, and storage medium for transmitting information, used for solving the technical problem of inaccurate phase noise estimation caused by low transmission precision of a PT-RS in the related art.

In the examples of the disclosure, when user equipment transmits a PT-RS by using the PT-RS port, at different transmission occasions, a PT-RS port will be alternately mapped to different DMRS ports, that is, at the different transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

In a method for transmitting information provided by an example of the disclosure, user equipment will obtain a target demodulation reference signal (DMRS) port associated with uplink phase-tracking reference signal (PT-RS) transmission, where the target DMRS port may be used for PT-RS transmission of a physical uplink shared channel (PUSCH) at a first transmission occasion; then the user equipment will determine a corresponding target DMRS port used for transmitting a PT-RS at each subsequent transmission occasion, where one PT-RS port corresponds to one target DMRS port at each transmission occasion, the target DMRS port is included in a DMRS port group associated with the corresponding PT-RS port, and target DMRS ports corresponding to two adjacent transmission occasions are different; and then, the PT-RS port will be mapped to a corresponding target DMRS port at each transmission occasion for transmitting the PT-RS.

It can thus be seen that, in the examples of the disclosure, when the user equipment transmits the PT-RS by using the PT-RS port, at different transmission occasions, the PT-RS port will be alternately mapped to different DMRS ports, that is, at the different transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

Method, apparatus, user equipment, base station, and storage medium for transmitting information provided by the disclosure are described in detail below with reference to the accompanying drawings.

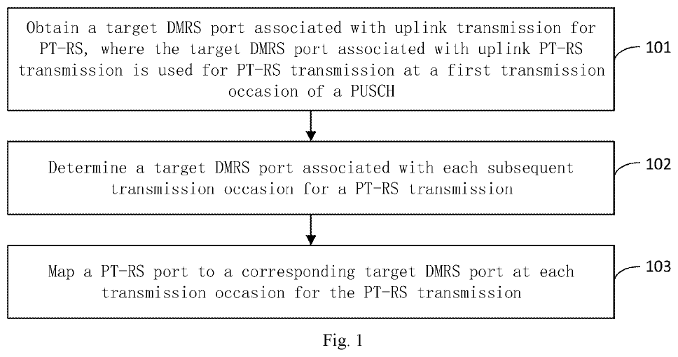

FIG. 1 is a schematic flow diagram of a method for transmitting information provided by an example of the disclosure. The method is performed by unified equipment (UE), and as shown in FIG. 1, the method for transmitting information may include the following steps:

Step 101, a target DMRS port associated with uplink transmission for phase-tracking reference signal (PT-RS) is obtained. The target DMRS port associated with uplink PT-RS transmission is used for PT-RS transmission of a PUSCH at a first transmission occasion.

It should be noted that, the UE may refer to equipment that provides a user with voice and/or data connectivity. The UE may communicate with one or more core networks through a radio access network (RAN). The UE may be internet of things terminals, such as a sensor device, a mobile phone (or called a “cellular” phone) and a computer with an internet of things terminal. For example, the UE may be fixed, portable, pocket-size, handheld, computer built-in or vehicle-mounted device. For example, the UE may be a station (STA), a subscriber unit, a subscriber station, a mobile station, a mobile, a remote station, an access point, a remote terminal, an access terminal, a user terminal, or a user agent. Or, the UE may also be an unmanned aircraft device. Or, the UE may also be a vehicle-mounted device, such as a trip computer with a wireless communication function, or a wireless terminal connected with an external trip computer. Or, the UE may also be a roadside device, such as a street lamp, a signal light or other roadside devices with wireless communication functions.

In one example of the disclosure, when the UE transmits a phase-tracking reference signal (PT-RS) to a base station, the PT-RS is usually repeatedly transmitted in sequence by using a plurality of PUSCH transmission occasions to ensure the success rate of PT-RS transmission. Besides, the UE will further transmit the PT-RS by using a multilayer transmission technology.

In one example of the disclosure, when the UE repeatedly transmits the PT-RS by using the multilayer transmission technology, corresponding target DMRS ports used for transmitting the PT-RS at two adjacent transmission occasions may be different, thus achieving alternate mapping of the DMRS ports during PT-RS transmission, so that different channels are adopted to transmit the PT-RS at different transmission occasions to ensure the PT-RS transmission precision.

Step 101 is mainly used for determining a corresponding target DMRS port used for transmitting the PT-RS at the first PUSCH transmission occasion.

In one example of the disclosure, the target DMRS port associated with uplink PT-RS transmission obtained by the UE may be configured by a base station.

Specifically, in one example of the disclosure, the base station usually pre-configures the target DMRS port associated with uplink PT-RS transmission for the UE. In the related art, after the UE obtains the target DMRS port configured by the base station, at each PUSCH transmission occasion, all PT-RS ports will be mapped to the target DMRS port configured by the base station. However, in one example of the disclosure, not all the PUSCH transmission occasion, the PT-RS ports are mapped to the target DMRS port configured by the base station, instead, merely the target DMRS port configured by the base station is mapped to PT-RS transmission at the first PUSCH transmission occasion, that is, the PT-RS ports are mapped to the target DMRS port configured by the base station merely at the first PUSCH transmission occasion, while the corresponding target DMRS port at each subsequent transmission occasion will be re-determined, thus achieving alternate mapping of the DMRS port during PT-RS transmission, so that different channels are adopted to transmit the PT-RS at different transmission occasions to ensure the PT-RS transmission precision.

Further, in one example of the disclosure, a method for the base station to preconfigure the target DMRS port associated with uplink PT-RS transmission for the UE may be that: the base station configures the target DMRS port associated with uplink PT-RS transmission through downlink control information (DCI) signaling.

It should be noted that, in one example of the disclosure, the UE may include a single PT-RS port or a plurality of PT-RS ports.

In one example of the disclosure, when the UE includes the single PT-RS port, the single PT-RS port is associated with a group of DMRS ports scheduled and assigned for the UE. A method for the base station to configure the target DMRS port for the PT-RS port may be that: a DMRS port group associated with the single PT-RS port is determined, one DMRS port is determined from the DMRS port group associated with the single PT-RS port as the target DMRS port corresponding to the single PT-RS port, and the target DMRS port is configured to the UE.

In another example of the disclosure, when the UE includes the plurality of PT-RS ports, each PT-RS port is associated with one DMRS port group. The DMRS port group associated with each PT-RS port is configured by the base station through high-layer signaling. Each PT-RS port corresponds to an alternate mapping parameter K. After the DMRS port group associated with each PT-RS port is determined and one DMRS port is determined from the DMRS port group associated with each PT-RS port correspondingly as the target DMRS port corresponding to each PT-RS port, the determined target DMRS port is configured to the UE.

In one example of the disclosure, the DMRS port groups associated with the PT-RS ports may be configured by the base station through high-layer signaling (e.g., radio resource control (RRC) signaling).

Specifically, in one example of the disclosure, when the UE includes the plurality of PT-RS ports, the base station may schedule and assign a group of DMRS ports for each PT-RS port through high-layer signaling as the DMRS port group associated with each PT-RS port. In another example of the disclosure, when the UE includes the single PT-RS port, the single PT-RS port may be directly associated with the group of DMRS ports scheduled and assigned for the UE.

It should be further noted that, in one example of the disclosure, the step that the base station configures the associated DMRS port groups for the plurality of PT-RS ports through the high-layer signaling respectively may be executed before step 101.

It can be seen from the above content that, in the example of the disclosure, one PT-RS port corresponds to one target DMRS port, and the target DMRS port is included in the DMRS port group associated with the corresponding PT-RS port.

Further, in one example of the disclosure, a method for the base station to determine the target DMRS port from the DMRS port group may include: defining a priority of channel quality of a channel corresponding to a DMRS port in the DMRS port group according to a possible quality distribution probability of a data layer, and determining the target DMRS port from the DMRS port group based on the priority. For example, a DMRS port with the best channel quality in the DMRS port group defined according to the possible quality distribution probability of the data layer may be determined as the target DMRS port.

For example, assuming that the UE merely includes a PT-RS port 0 (i.e., the 0^{th} scheduled PT-RS port of the UE), a DMRS port group corresponding to the PT-RS port 0 is: a DMRS port 0 (i.e., the 0^{th} scheduled DMRS port in the DMRS port group associated with the PT-RS port 0), a DMRS port 1 (i.e., the 1^{st} scheduled DMRS port in the DMRS port group associated with the PT-RS port 0), a DMRS port 2 (i.e., the 2^{nd} scheduled DMRS port in the DMRS port group associated with the PT-RS port 0), and a DMRS port 3 (i.e., the 3^{rd} scheduled DMRS port in the DMRS port group associated with the PT-RS port 0). The channel quality of a channel corresponding to the DMRS port 2 defined according to the possible quality distribution probability of the data layer is the best, so that the base station may determine the DMRS port 2 as a target DMRS port corresponding to the PT-RS port 0 and configure the DMRS port 2 to the UE through DCI signaling.

Assuming that the UE includes a PT-RS port 0 and a PT-RS port 1 (i.e., the 1^{st} scheduled PT-RS port of the UE), a first DMRS port group corresponding to the PT-RS port 0 is: a DMRS port 0 (i.e., the 0^{th} scheduled DMRS port in the first DMRS port group), and a DMRS port 1 (i.e., the 1^{st} scheduled DMRS port in the first DMRS port group); and a second DMRS port group corresponding to the PT-RS port 1 is: a DMRS port 0 (i.e., the 0^{th} scheduled DMRS port in the second DMRS port group), and a DMRS port 1 (i.e., the 1^{st} scheduled DMRS port in the second DMRS port group). The channel quality of a channel corresponding to the DMRS port 1 in the first DMRS port group defined according to the possible quality distribution probability of the data layer is the best, and the channel quality of a channel corresponding to the DMRS port 0 in the second DMRS port group is the best, so that the base station may determine the DMRS port 1 in the first DMRS port group as a target DMRS port corresponding to the PT-RS port 0, determine the DMRS port 0 in the second DMRS port group as a target DMRS port corresponding to the PT-RS port 1, and configure the DMRS port 1 in the first DMRS port group and the DMRS port 0 in the second DMRS port group to the UE through DCI signaling.

In another example of the disclosure, a method for the base station to determine the target DMRS port from the DMRS port group may include: determining any one of the DMRS port in the DMRS port group as the target DMRS port.

In one example of the disclosure, when the UE determines the target DMRS port associated with uplink PT-RS transmission, the determined target DMRS port may be configured into the UE, so that the UE uses the target DMRS port configured by the base station for PT-RS transmission at the first PUSCH transmission occasion.

Specifically, in one example of the disclosure, at the first PUSCH transmission occasion, the PT-RS may be mapped to the target DMRS port indicated by the base station so as to transmit the DMRS port.

Step 102, a target DMRS port associated with each subsequent transmission occasion for a PT-RS transmission is determined.

In one example of the disclosure, after the target DMRS port corresponding to transmission of the PT-RS at the first PUSCH transmission occasion is determined, the corresponding target DMRS port used for transmitting the PT-RS at each subsequent transmission occasion may further continue to be determined. Moreover, target DMRS ports corresponding to two adjacent transmission occasions are different, so that alternate mapping of the DMRS ports during PT-RS transmission is achieved.

In one example of the disclosure, the UE may determine the corresponding target DMRS port used for transmitting the PT-RS at each subsequent transmission occasion according to a port selecting rule and an alternate mapping parameter K.

In one example of the disclosure, the alternate mapping parameter K is used for indicating the number of alternate mapping DMRS ports supported by the UE on a PT-RS port, K is a positive integer, and 2≤K≤the number of the DMRS ports in the DMRS port group associated with the PT-RS port.

For example, when the alternate mapping parameter K corresponding to the PT-RS port is 2, it shows that the PT-RS port supports alternate mapping in two DMRS ports. Thus, the UE may select two DMRS ports in the PT-RS port according to the port selecting rule to use the two DMRS ports as the corresponding target DMRS ports used for transmitting the PT-RS at each subsequent transmission occasion, and it should be ensured that the target DMRS ports corresponding to two adjacent transmission occasions are different.

It should be noted that, in the example of the disclosure, one PT-RS port corresponds to one alternate mapping parameter K. Moreover, in one example of the disclosure, the alternate mapping parameters K corresponding to different PT-RS ports may be the same. In another example of the disclosure, the alternate mapping parameters K corresponding to different PT-RS ports may be different.

Further, in one example of the disclosure, the port selecting rule may include: defining a priority of channel quality of a channel corresponding to a DMRS port according to a possible quality distribution probability of a data layer, and selecting the target DMRS port based on the priority. For example, first K DMRS ports with the channel quality of corresponding channels in the DMRS port group defined according to the possible quality distribution probability of the data layer ranked from high to low may be determined as the target DMRS ports. In another example of the disclosure, the port selecting rule may include: randomly selecting K DMRS ports in the DMRS port group as the target DMRS ports.

In one example of the disclosure, the port selecting rule and/or the alternate mapping parameter K may be predefined (i.e., default). In one example of the disclosure, the port selecting rule and/or the alternate mapping parameter K may be configured by the base station through high-layer signaling. It should be noted that, in one example of the disclosure, when the base station does not configure the port selecting rule, the UE may determine the target DMRS port according to a predefined port selecting rule. In another example of the disclosure, when the base station does not configure the alternate mapping parameter K, the UE may determine the target DMRS port according to a predefined alternate mapping parameter K.

Furthermore, in one example of the disclosure, the UE may include a single PT-RS port. In another example of the disclosure, the UE may include a plurality of PT-RS ports.

In one example of the disclosure, when the UE includes the single PT-RS port, the single PT-RS port is associated with a group of DMRS ports scheduled and assigned for the UE. A method for determining the corresponding target DMRS port used for transmitting the PT-RS at each subsequent transmission occasion may be that: as for the single PT-RS port, the corresponding target DMRS port at each subsequent transmission occasion is determined from the associated DMRS port group according to the port selecting rule and the alternate mapping parameter K.

In another example of the disclosure, when the UE includes the plurality of PT-RS ports, each PT-RS port is associated with one DMRS port group. The DMRS port group associated with each PT-RS port is configured by the base station through high-layer signaling. Each PT-RS port corresponds to an alternate mapping parameter K. A method for determining the corresponding target DMRS port used for transmitting the PT-RS at each subsequent transmission occasion may be that: as for each PT-RS port used for transmitting the PT-RS, the corresponding target DMRS port at each subsequent transmission occasion is correspondingly determined from the associated DMRS port group according to the port selecting rule and the alternate mapping parameter K.

Step 103, a PT-RS port is mapped to a corresponding target DMRS port at each transmission occasion for the PT-RS transmission.

In one example of the disclosure, after the corresponding target DMRS port used for transmitting the PT-RS at each transmission occasion is determined, when each transmission occasion is reached, the PT-RS port will be mapped to the corresponding target DMRS port to transmit the PT-RS, thus achieving alternate mapping.

It should be noted that, in one example of the disclosure, the PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, at two adjacent transmission occasions, the PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” is avoided, the PT-RS transmission precision is ensured, the accuracy of phase noise estimation is ensured, and the problem of inaccurate phase noise estimation caused by channel changes and estimation delay is solved.

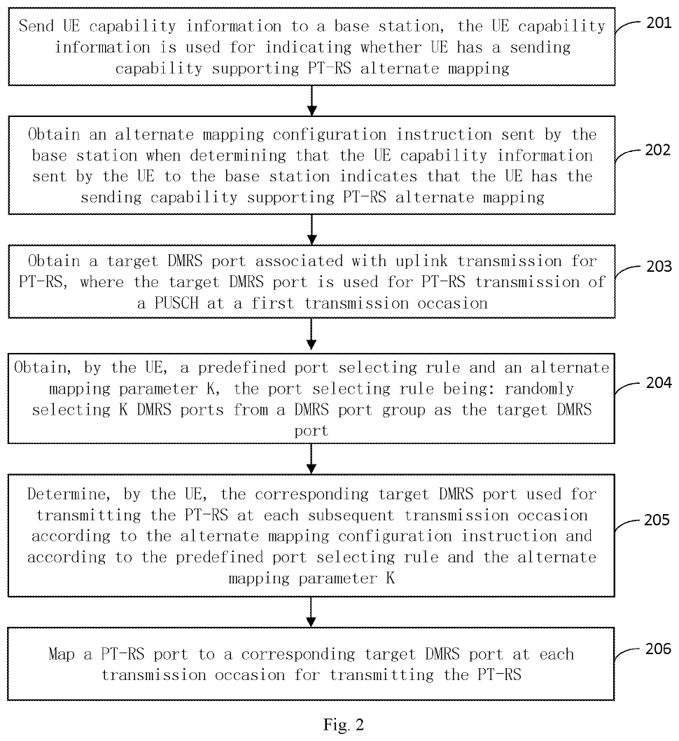

FIG. 2 is a schematic flow diagram of a method for transmitting information provided by another example of the disclosure. The method is performed by UE, and as shown in FIG. 2, the information transmission method may include the following steps:

Step 201, UE capability information is sent to a base station, the UE capability information is used for indicating whether the UE has a sending capability supporting PT-RS alternate mapping.

In one example of the disclosure, PT-RS alternate mapping means that: PT-RS ports of the UE may be alternately mapped to different DMRS ports at different transmission occasions. For example, at a first transmission occasion, a PT-RS port 0 may be mapped to a DMRS port 0; at a second transmission occasion, the PT-RS port 0 may be mapped to a DMRS port 1; and at a third transmission occasion, the PT-RS port 0 may be mapped to a DMRS port 3.

In one example of the disclosure, when the UE has the sending capability supporting PT-RS alternate mapping, this subsequent step that “a corresponding target DMRS port used for transmitting a PT-RS at each transmission occasion is determined” may be executed.

Step 202, an alternate mapping configuration instruction sent by the base station is obtained when the UE capability information sent by the UE to the base station indicates that the UE has the sending capability supporting PT-RS alternate mapping, the alternate mapping configuration instruction being used for indicating the UE to transmit the PT-RS according to PT-RS alternate mapping.

In one example of the disclosure, when the UE capability information sent by the UE to the base station indicates that the UE has the sending capability supporting PT-RS alternate mapping, the base station may send the alternate mapping configuration instruction to the UE, such that the UE may execute the next step that “the corresponding target DMRS port used for transmitting the PT-RS at each subsequent transmission occasion is determined” according to the alternate mapping configuration instruction.

In another example of the disclosure, when the UE capability information sent by the UE to the base station indicates that the UE has the sending capability supporting PT-RS alternate mapping, the base station may also not send the alternate mapping configuration instruction to the UE, and at the moment, the UE may determine a target DMRS port configured by the base station in next step 203 as the corresponding target DMRS port for transmitting the PT-RS at each subsequent transmission occasion.

It should be noted that, in one example of the disclosure, the base station may determine whether to send the alternate mapping configuration instruction to the UE according to the number of layers of channels and/or channel quality. In one example of the disclosure, the base station may configure the alternate mapping configuration instruction to the UE through radio resource control (RRC) signaling.

Step 203, the target DMRS port associated with uplink PT-RS transmission is obtained. The target DMRS port is used for PT-RS transmission of a PUSCH at a first transmission occasion.

In one example of the disclosure, detailed introduction of this step may refer to step 101, which is not repeated here in the present example.

In one example of the disclosure, the base station may determine the target DMRS port associated with uplink PT-RS transmission from a DMRS port group associated with the PT-RS ports according to a predefined port selecting rule. In one example of the disclosure, the DMRS port groups associated with the PT-RS ports may be configured by the base station through high-layer signaling.

Step 204, the UE obtains the predefined port selecting rule and an alternate mapping parameter K, the port selecting rule being: randomly selecting K DMRS ports from a DMRS port group as the target DMRS port.

In one example of the disclosure, when the base station does not configure the port selecting rule and the alternate mapping parameter K to the UE, the UE may obtain the predefined (e.g., default) port selecting rule and the alternate mapping parameter K.

In one example of the disclosure, the alternate mapping parameter K is used for indicating the number of alternate mapping DMRS ports supported by the UE on a PT-RS port, K is a positive integer, and 2≤K≤the number of the DMRS ports in the DMRS port group associated with the PT-RS port.

For example, when the alternate mapping parameter K corresponding to the PT-RS port is 2, it shows that the PT-RS port supports alternate mapping in two DMRS ports. Thus, the UE may select two DMRS ports in the PT-RS port according to the port selecting rule to use the two DMRS ports as the corresponding target DMRS ports used for transmitting the PT-RS at each subsequent transmission occasion, and it should be ensured that the target DMRS ports corresponding to two adjacent transmission occasions are different.

It should be noted that, in the example of the disclosure, one PT-RS port corresponds to one alternate mapping parameter K. Moreover, in one example of the disclosure, the alternate mapping parameters K corresponding to different PT-RS ports may be the same. In another example of the disclosure, the alternate mapping parameters K corresponding to different PT-RS ports may be different.

In one example of the disclosure, the predefined alternate mapping parameter K may be equal to the number of the DMRS port groups associated with the PT-RS ports. In another example of the disclosure, the predefined alternate mapping parameter K may be less than the number of the DMRS port groups associated with the PT-RS ports.

It should be noted that, in one example of the disclosure, the port selecting rule predefined by the UE and the port selecting rule predefined by the base station may be the same. In another example of the disclosure, the port selecting rule predefined by the UE and the port selecting rule predefined by the base station may also be different.

Step 205, the UE determines the corresponding target DMRS port used for transmitting the PT-RS at each subsequent transmission occasion according to the alternate mapping configuration instruction and according to the predefined port selecting rule and the alternate mapping parameter K.

In another example of the disclosure, the UE may include a single PT-RS port. In another example of the disclosure, the UE may include a plurality of PT-RS ports.

In one example of the disclosure, when the UE includes the single PT-RS port, the single PT-RS port is associated with a group of DMRS ports scheduled and assigned for the UE. A method for determining the corresponding target DMRS port used for transmitting the PT-RS at each subsequent transmission occasion may be that: as for the single PT-RS port, the corresponding target DMRS port at each subsequent transmission occasion is determined from the associated DMRS port group according to the port selecting rule and the alternate mapping parameter K.

In another example of the disclosure, when the UE includes the plurality of PT-RS ports, each PT-RS port is associated with one DMRS port group. The DMRS port group associated with each PT-RS port is configured by the base station through high-layer signaling. Each PT-RS port corresponds to an alternate mapping parameter K. A method for determining the corresponding target DMRS port used for transmitting the PT-RS at each subsequent transmission occasion may be that: as for each PT-RS port used for transmitting the PT-RS, the corresponding target DMRS port at each subsequent transmission occasion is correspondingly determined from the associated DMRS port group according to the port selecting rule and the alternate mapping parameter K.

Further, in the example of the disclosure, the UE determining the target DMRS port corresponding each subsequent transmission occasion from the associated DMRS port group according to the port selecting rule and the alternate mapping parameter K, may include:

K target DMRS ports from the associated DMRS port group according to the port selecting rule and the alternate mapping parameter K is determined, and then the K target DMRS ports as the corresponding target DMRS ports used for transmitting the PT-RS at each subsequent transmission occasion respectively is determined.

For example, assuming that the UE merely includes the PT-RS port 0, a DMRS port group corresponding to the PT-RS port 0 is: a DMRS port 0, a DMRS port 1, a DMRS port 2 and a DMRS port 3. The UE will repeatedly transmit the PT-RS by using a first transmission occasion, a second transmission occasion, a third transmission occasion and a fourth transmission occasion respectively. The target DMRS port configured by the base station obtained by the UE through step 203 above is the DMRS port 2, and the alternate mapping parameter K determined by the UE through step 203 above is 2, so that the port selecting rule is: randomly selecting K DMRS ports in the DMRS port group as the target DMRS ports.

Based on this, in another example of the disclosure, in this step, a method for the UE to determine the corresponding target DMRS port used for transmitting the PT-RS at each subsequent transmission occasion according to the alternate mapping configuration instruction and according to the predefined port selecting rule and the alternate mapping parameter K may be that: the DMRS port 2 and the DMRS port 0 are determined as the target DMRS ports corresponding the subsequent transmission occasions, and alternate mapping is performed between the DMRS port 2 and the DMRS port 0 at the subsequent transmission occasions, for example, at the second transmission occasion, the PT-RS port 0 is mapped to the DMRS port 0, at the third transmission occasion, the PT-RS port 0 is mapped to the DMRS port 2, and at the fourth transmission occasion, the PT-RS port 0 is mapped to the DMRS port 0.

Alternatively, in another example of the disclosure, the DMRS port 2 and the DMRS port 3 may be determined as the target DMRS ports corresponding the subsequent transmission occasions, and alternate mapping is performed between the DMRS port 2 and the DMRS port 3 at the subsequent transmission occasions, for example, at the second transmission occasion, the PT-RS port 0 is mapped to the DMRS port 3, at the third transmission occasion, the PT-RS port 0 is mapped to the DMRS port 2, and at the fourth transmission occasion, the PT-RS port 0 is mapped to the DMRS port 3.

It should be noted that, in one example of the disclosure, the target DMRS ports corresponding the subsequent transmission occasions determined in this step may include the target DMRS port configured by the base station in step 203. In another example of the disclosure, the target DMRS ports corresponding the subsequent transmission occasions determined in this step may not include the target DMRS port configured by the base station in step 203.

Step 206, a PT-RS port is mapped to the corresponding target DMRS port at each transmission occasion for transmitting the PT-RS.

In one example of the disclosure, after the corresponding target DMRS port used for transmitting the PT-RS at each transmission occasion is determined, when each transmission occasion is reached, the PT-RS port will be mapped to the corresponding target DMRS port to transmit the PT-RS, thus achieving alternate mapping.

It should be noted that, in one example of the disclosure, the PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, at two adjacent transmission occasions, the PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” is avoided, the PT-RS transmission precision is ensured, the accuracy of phase noise estimation is ensured, and the problem of inaccurate phase noise estimation caused by channel changes and estimation delay is solved.

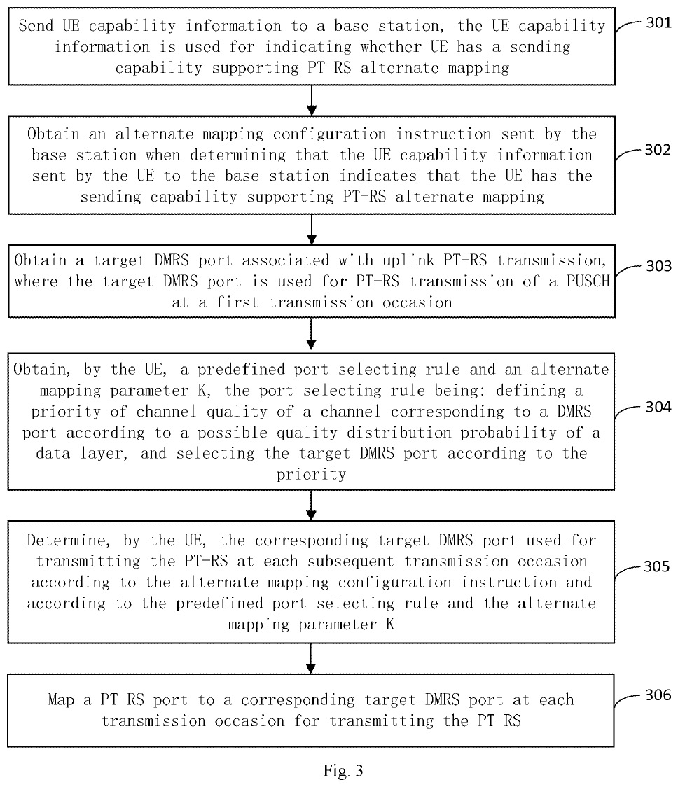

FIG. 3 is a schematic flow diagram of a method for transmitting information provided by another example of the disclosure. The method is performed by UE, and as shown in FIG. 3, the information transmission method may include the following steps:

Step 301, UE capability information is sent to a base station, the UE capability information is used for indicating whether the UE has a sending capability supporting PT-RS alternate mapping.

In one example of the disclosure, PT-RS alternate mapping means that: PT-RS ports of the UE may be alternately mapped to different DMRS ports at different transmission occasions. For example, at a first transmission occasion, a PT-RS port 0 may be mapped to a DMRS port 0; at a second transmission occasion, the PT-RS port 0 may be mapped to a DMRS port 1; and at a third transmission occasion, the PT-RS port 0 may be mapped to a DMRS port 3.

In one example of the disclosure, when the UE has the sending capability supporting PT-RS alternate mapping, this subsequent step that “a corresponding target DMRS port used for transmitting a PT-RS at each transmission occasion is determined” may be executed.

Step 302, an alternate mapping configuration instruction sent by the base station is obtained when to the UE capability information sent by the UE to the base station indicates that the UE has the sending capability supporting PT-RS alternate mapping, the alternate mapping configuration instruction being used for indicating the UE to transmit the PT-RS according to PT-RS alternate mapping.

In one example of the disclosure, when the UE capability information sent by the UE to the base station indicates that the UE has the sending capability supporting PT-RS alternate mapping, the base station may send the alternate mapping configuration instruction to the UE, such that the UE may execute the next step that “the target DMRS port used for transmitting the PT-RS corresponding each subsequent transmission occasion is determined” according to the alternate mapping configuration instruction.

In another example of the disclosure, when the UE capability information sent by the UE to the base station indicates that the UE has the sending capability supporting PT-RS alternate mapping, the base station may also not send the alternate mapping configuration instruction to the UE, and at the moment, the UE may determine a target DMRS port configured by the base station in next step 303 as the target DMRS port for transmitting the PT-RS corresponding each subsequent transmission occasion.

Step 303, the target DMRS port associated with uplink PT-RS transmission is obtained. The target DMRS port is used for PT-RS transmission of a PUSCH at a first transmission occasion.

In one example of the disclosure, detailed introduction of this step may refer to step 101, which is not repeated here in the present example.

In one example of the disclosure, the base station may determine the target DMRS port associated with uplink PT-RS transmission from a DMRS port group associated with the PT-RS ports according to a predefined port selecting rule. In one example of the disclosure, the DMRS port groups associated with the PT-RS ports may be configured by the base station through high-layer signaling.

Step 304, the UE obtains a predefined port selecting rule and an alternate mapping parameter K, the port selecting rule being: defining a priority of channel quality of a channel corresponding to a DMRS port according to a possible quality distribution probability of a data layer, and selecting the target DMRS port according to the priority.

In one example of the disclosure, when the base station does not configure the port selecting rule and the alternate mapping parameter K to the UE, the UE may obtain the predefined (e.g., default) port selecting rule and the alternate mapping parameter K.

In one example of the disclosure, the alternate mapping parameter K is used for indicating the number of alternate mapping DMRS ports supported by the UE on a PT-RS port, K is a positive integer, and 2≤K≤the number of the DMRS ports in the DMRS port group associated with the PT-RS port.

For example, when the alternate mapping parameter K corresponding to the PT-RS port is 2, it shows that the PT-RS port supports alternate mapping in two DMRS ports. Thus, the UE may select two DMRS ports in the PT-RS port according to the port selecting rule to use the two DMRS ports as the corresponding target DMRS ports used for transmitting the PT-RS at each subsequent transmission occasion, and it should be ensured that the target DMRS ports corresponding to two adjacent transmission occasions are different.

It should be noted that, in the example of the disclosure, one PT-RS port corresponds to one alternate mapping parameter K. Moreover, in one example of the disclosure, the alternate mapping parameters K corresponding to different PT-RS ports may be the same. In another example of the disclosure, the alternate mapping parameters K corresponding to different PT-RS ports may be different.

In one example of the disclosure, the predefined alternate mapping parameter K may be equal to the number of the DMRS port groups associated with the PT-RS ports. In another example of the disclosure, the predefined alternate mapping parameter K may be less than the number of the DMRS port groups associated with the PT-RS ports.

The port selecting rule may include: defining a priority of channel quality of a channel corresponding to a DMRS port according to a possible quality distribution probability of a data layer, and selecting the target DMRS port according to the priority. For example, first K DMRS ports with the channel quality of corresponding channels in the DMRS port group defined according to the possible quality distribution probability of the data layer ranked from high to low may be determined as the target DMRS ports.

It should be noted that, in one example of the disclosure, the port selecting rule predefined by the UE and the port selecting rule predefined by the base station may be the same. In another example of the disclosure, the port selecting rule predefined by the UE and the port selecting rule predefined by the base station may also be different.

Step 305, the UE determines the target DMRS port used for transmitting the PT-RS corresponding each subsequent transmission occasion according to the alternate mapping configuration instruction and according to the predefined port selecting rule and the alternate mapping parameter K.

In another example of the disclosure, the UE may include a single PT-RS port. In another example of the disclosure, the UE may include a plurality of PT-RS ports.

In one example of the disclosure, when the UE includes the single PT-RS port, the single PT-RS port is associated with a group of DMRS ports scheduled and assigned for the UE. A method for determining the corresponding target DMRS port used for transmitting the PT-RS at each subsequent transmission occasion may be that: as for the single PT-RS port, the corresponding target DMRS port at each subsequent transmission occasion is determined from the associated DMRS port group according to the port selecting rule and the alternate mapping parameter K.

In another example of the disclosure, when the UE includes the plurality of PT-RS ports, each PT-RS port is associated with one DMRS port group. The DMRS port group associated with each PT-RS port is configured by the base station through high-layer signaling. Each PT-RS port corresponds to an alternate mapping parameter K. A method for determining the corresponding target DMRS port used for transmitting the PT-RS at each subsequent transmission occasion may be that: as for each PT-RS port used for transmitting the PT-RS, the corresponding target DMRS port at each subsequent transmission occasion is correspondingly determined from the associated DMRS port group according to the port selecting rule and the alternate mapping parameter K.

Further, in the example of the disclosure, the UE determining the target DMRS port corresponding each subsequent transmission occasion from the associated DMRS port group according to the port selecting rule and the alternate mapping parameter K, may include:

K target DMRS ports from the associated DMRS port group according to the port selecting rule and the alternate mapping parameter K is determined, and then the K target DMRS ports as the corresponding target DMRS ports used for transmitting the PT-RS at each subsequent transmission occasion respectively is determined.

For example, assuming that the UE merely includes the PT-RS port 0, a DMRS port group corresponding to the PT-RS port 0 is: a DMRS port 0, a DMRS port 1, a DMRS port 2 and a DMRS port 3. The UE will repeatedly transmit the PT-RS by using a first transmission occasion, a second transmission occasion, a third transmission occasion and a fourth transmission occasion respectively. The target DMRS port configured by the base station obtained by the UE through step 303 above is the DMRS port 0, the alternate mapping parameter K determined by the UE through step 304 above is 2, and the port selecting rule is: defining a priority of channel quality of a channel corresponding to a DMRS port according to a possible quality distribution probability of a data layer, and selecting the target DMRS port according to the priority.

Based on this, in another example of the disclosure, a method for the UE to determine the target DMRS port used for transmitting the PT-RS corresponding each subsequent transmission occasion according to the alternate mapping configuration instruction and according to the predefined port selecting rule and the alternate mapping parameter K may be that: a rank from high to low of the channel quality of channels corresponding to the DMRS port 0, the DMRS port 1, the DMRS port 2 and the DMRS port 3 at each transmission occasion is defined according to the possible quality distribution probability of the data layer, the first two DMRS ports with the channel quality of the channels corresponding to the DMRS port 0, the DMRS port 1, the DMRS port 2 and the DMRS port 3 at certain transmission occasion (i.e., the first transmission occasion, or the second transmission occasion, or the third transmission occasion or the fourth transmission occasion) from high to low are determined as the target DMRS ports, and alternate mapping is performed between the first two DMRS ports at subsequent transmission occasions.

For example, assuming that a rank from high to low of the channel quality of the channels corresponding to the DMRS port 0, the DMRS port 1, the DMRS port 2 and the DMRS port 3 at the second transmission occasion according to the possible quality distribution probability of the data layer is: DMRS port 0>DMRS port 1>DMRS port 2>DMRS port 3, then the DMRS port 0 and the DMRS port 1 may be determined as the target DMRS ports, and alternate mapping is performed between the DMRS port 0 and the DMRS port 1 at the subsequent transmission occasions, for example, at the second transmission occasion, the PT-RS port 0 is mapped to the DMRS port 0, at the third transmission occasion, the PT-RS port 0 is mapped to the DMRS port 1, and at the fourth transmission occasion, the PT-RS port 0 is mapped to the DMRS port 0.

It should be noted that, in one example of the disclosure, the target DMRS ports corresponding the subsequent transmission occasions determined in this step may include the target DMRS port configured by the base station in step 303. In another example of the disclosure, the target DMRS ports corresponding the subsequent transmission occasions determined in this step may not include the target DMRS port configured by the base station in step 303.

Step 306, a PT-RS port is mapped to the corresponding target DMRS port at each transmission occasion for transmitting the PT-RS.

In one example of the disclosure, after the corresponding target DMRS port used for transmitting the PT-RS at each transmission occasion is determined, when each transmission occasion is reached, the PT-RS port will be mapped to the corresponding target DMRS port to transmit the PT-RS, thus achieving alternate mapping.

It should be noted that, in one example of the disclosure, the PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, at two adjacent transmission occasions, the PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” is avoided, the PT-RS transmission precision is ensured, the accuracy of phase noise estimation is ensured, and the problem of inaccurate phase noise estimation caused by channel changes and estimation delay is solved.

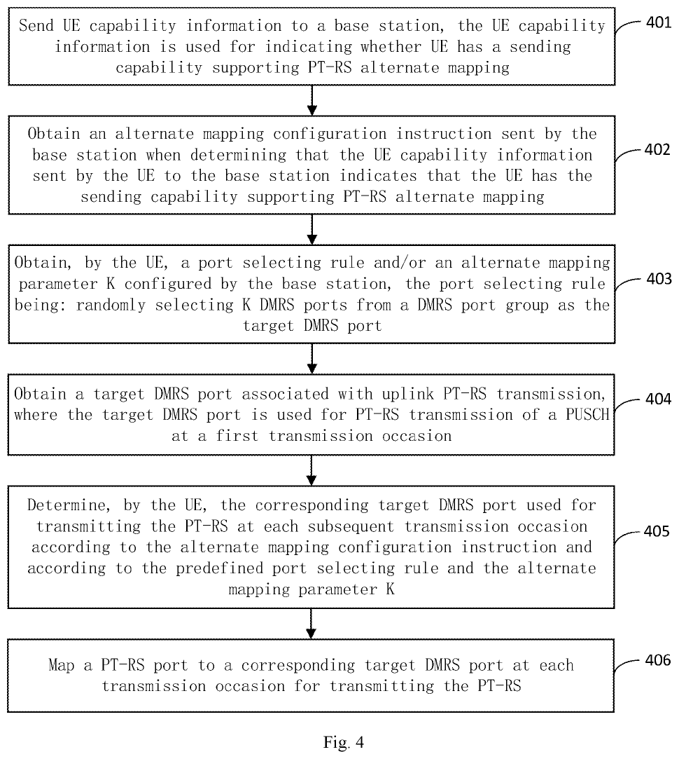

FIG. 4 is a schematic flow diagram of a method for transmitting information provided by another example of the disclosure. The method is performed by UE, and as shown in FIG. 4, the information transmission method may include the following steps:

Step 401, UE capability information is sent to a base station, the UE capability information being used for indicating whether the UE has a sending capability supporting PT-RS alternate mapping.

In one example of the disclosure, PT-RS alternate mapping means that: PT-RS ports of the UE may be alternately mapped to different DMRS ports at different transmission occasions. For example, at a first transmission occasion, a PT-RS port 0 may be mapped to a DMRS port 0; at a second transmission occasion, the PT-RS port 0 may be mapped to a DMRS port 1; and at a third transmission occasion, the PT-RS port 0 may be mapped to a DMRS port 3.

In one example of the disclosure, when the UE has the sending capability supporting PT-RS alternate mapping, this subsequent step that “a corresponding target DMRS port used for transmitting a PT-RS at each transmission occasion is determined” may be executed.

Step 402, an alternate mapping configuration instruction sent by the base station is obtained when the UE capability information sent by the UE to the base station indicates that the UE has the sending capability supporting PT-RS alternate mapping, the alternate mapping configuration instruction being used for indicating the UE to transmit the PT-RS according to PT-RS alternate mapping.

In one example of the disclosure, when the UE capability information sent by the UE to the base station indicates that the UE has the sending capability supporting PT-RS alternate mapping, the base station may send the alternate mapping configuration instruction to the UE, such that the UE may execute the next step that “the corresponding target DMRS port used for transmitting the PT-RS at each subsequent transmission occasion is determined” according to the alternate mapping configuration instruction.

In another example of the disclosure, when the UE capability information sent by the UE to the base station indicates that the UE has the sending capability supporting PT-RS alternate mapping, the base station may also not send the alternate mapping configuration instruction to the UE, and at the moment, the UE may determine a target DMRS port configured by the base station in next step 404 as the corresponding target DMRS port for transmitting the PT-RS at each subsequent transmission occasion.

Step 403, the UE obtains a port selecting rule and/or an alternate mapping parameter K configured by the base station, the port selecting rule being: randomly selecting K DMRS ports from a DMRS port group as the target DMRS port.

In one example of the disclosure, the base station may configure the port selecting rule and/or the alternate mapping parameter K to the UE. It should be noted that, in one example of the disclosure, when the base station does not configure the port selecting rule, the UE may determine the target DMRS port according to a predefined port selecting rule. In another example of the disclosure, when the base station does not configure the alternate mapping parameter K, the UE may determine the target DMRS port according to a predefined alternate mapping parameter K.

In one example of the disclosure, the alternate mapping parameter K is used for indicating the number of alternate mapping DMRS ports supported by the UE on a PT-RS port, K is a positive integer, and 2≤K≤the number of the DMRS ports in the DMRS port group associated with the PT-RS port.

For example, when the alternate mapping parameter K corresponding to the PT-RS port is 2, it shows that the PT-RS port supports alternate mapping in two DMRS ports. Thus, the UE may select two DMRS ports in the PT-RS port according to the port selecting rule to use the two DMRS ports as the corresponding target DMRS ports used for transmitting the PT-RS at each subsequent transmission occasion, and it should be ensured that the target DMRS ports corresponding to two adjacent transmission occasions are different.

It should be noted that, in the example of the disclosure, one PT-RS port corresponds to one alternate mapping parameter K. Moreover, in one example of the disclosure, the alternate mapping parameters K corresponding to different PT-RS ports may be the same. In another example of the disclosure, the alternate mapping parameters K corresponding to different PT-RS ports may be different.

In one example of the disclosure, the alternate mapping parameter K may be equal to the number of the DMRS port groups associated with the PT-RS ports. In another example of the disclosure, the alternate mapping parameter K may be less than the number of the DMRS port groups associated with the PT-RS ports.

In one example of the disclosure, a method for the base station to configure the alternate mapping parameter K may include: directly determining, by the base station, the alternate mapping parameter.

In another example of the disclosure, the method for the base station to configure the alternate mapping parameter K may include: transmitting, by the UE to the base station, an alternate mapping support parameter K1. The alternate mapping support parameter K1 is used for indicating the number of alternate mapping DMRS ports supported by the UE on each PT-RS port, K1 is a positive integer, and 2≤K1≤the number of the DMRS ports in the DMRS port group associated with the PT-RS port. The base station determines the alternate mapping parameter K according to the alternate mapping support parameter K1, where K≤K1, and configures the determined alternate mapping parameter K to the UE.

Step 404, the target DMRS port associated with uplink PT-RS transmission is obtained. The target DMRS port is used for PT-RS transmission of a PUSCH at a first transmission occasion.

In one example of the disclosure, detailed introduction of this step may refer to step 101, which is not repeated here in the present example.

In one example of the disclosure, the base station may determine the target DMRS port associated with uplink PT-RS transmission from the DMRS port group associated with the PT-RS ports according to the port selecting rule configured by the base station for the UE. In one example of the disclosure, the DMRS port groups associated with the PT-RS ports may be configured by the base station through high-layer signaling.

Specifically, it can be seen from step 403 that, the port selecting rule configured by the base station is: randomly selecting the target DMRS port in the DMRS port group. Based on this, in one example of the disclosure, a method for the base station to configure the target DMRS port associated with uplink PT-RS transmission according to the port selecting rule may include: determining any one of DMRS port in the DMRS port group associated with the PT-RS ports as the target DMRS port.

Step 405, the UE determines the corresponding target DMRS port used for transmitting the PT-RS at each subsequent transmission occasion according to the alternate mapping configuration instruction and according to the predefined port selecting rule and the alternate mapping parameter K.

In another example of the disclosure, the UE may include a single PT-RS port. In another example of the disclosure, the UE may include a plurality of PT-RS ports.

In one example of the disclosure, when the UE includes the single PT-RS port, the single PT-RS port is associated with a group of DMRS ports scheduled and assigned for the UE. A method for determining the corresponding target DMRS port used for transmitting the PT-RS at each subsequent transmission occasion may be that: as for the single PT-RS port, the corresponding target DMRS port at each subsequent transmission occasion is determined from the associated DMRS port group according to the port selecting rule and the alternate mapping parameter K.

In another example of the disclosure, when the UE includes the plurality of PT-RS ports, each PT-RS port is associated with one DMRS port group. The DMRS port group associated with each PT-RS port is configured by the base station through high-layer signaling. Each PT-RS port corresponds to an alternate mapping parameter K. A method for determining the corresponding target DMRS port used for transmitting the PT-RS at each subsequent transmission occasion may be that: as for each PT-RS port used for transmitting the PT-RS, the corresponding target DMRS port at each subsequent transmission occasion is correspondingly determined from the associated DMRS port group according to the port selecting rule and the alternate mapping parameter K.

Further, in the example of the disclosure, the UE determining the target DMRS port corresponding each subsequent transmission occasion from the associated DMRS port group according to the port selecting rule and the alternate mapping parameter K, may include:

K target DMRS ports from the associated DMRS port group according to the port selecting rule and the alternate mapping parameter K is determined, and then determining the K target DMRS ports as the corresponding target DMRS ports used for transmitting the PT-RS at each subsequent transmission occasion respectively is determined.

For example, assuming that the UE merely includes the PT-RS port 0, a DMRS port group corresponding to the PT-RS port 0 is: a DMRS port 0, a DMRS port 1, a DMRS port 2 and a DMRS port 3. The UE will repeatedly transmit the PT-RS by using a first transmission occasion, a second transmission occasion, a third transmission occasion and a fourth transmission occasion respectively. The target DMRS port configured by the base station obtained by the UE through step 404 above is the DMRS port 2, and the alternate mapping parameter K determined by the UE through step 403 above is 2, so that the port selecting rule is: randomly selecting K DMRS ports in the DMRS port group as the target DMRS ports.

Based on this, in another example of the disclosure, in this step, a method for the UE to determine the corresponding target DMRS port used for transmitting the PT-RS at each subsequent transmission occasion according to the alternate mapping configuration instruction and according to the predefined port selecting rule and the alternate mapping parameter K may be that: the DMRS port 2 and the DMRS port 0 are determined as the target DMRS ports corresponding the subsequent transmission occasions, and alternate mapping is performed between the DMRS port 2 and the DMRS port 0 at the subsequent transmission occasions, for example, at the second transmission occasion, the PT-RS port 0 is mapped to the DMRS port 0, at the third transmission occasion, the PT-RS port 0 is mapped to the DMRS port 2, and at the fourth transmission occasion, the PT-RS port 0 is mapped to the DMRS port 0.

Alternatively, in another example of the disclosure, the DMRS port 2 and the DMRS port 3 may be determined as the target DMRS ports corresponding the subsequent transmission occasions, and alternate mapping is performed between the DMRS port 2 and the DMRS port 3 at the subsequent transmission occasions, for example, at the second transmission occasion, the PT-RS port 0 is mapped to the DMRS port 3, at the third transmission occasion, the PT-RS port 0 is mapped to the DMRS port 2, and at the fourth transmission occasion, the PT-RS port 0 is mapped to the DMRS port 3.

It should be noted that, in one example of the disclosure, the target DMRS ports corresponding the subsequent transmission occasions determined in this step may include the target DMRS port configured by the base station in step 404. In another example of the disclosure, the target DMRS ports corresponding the subsequent transmission occasions determined in this step may not include the target DMRS port configured by the base station in step 404.

Step 406, a PT-RS port is mapped to the corresponding target DMRS port at each transmission occasion for transmitting the PT-RS.

In one example of the disclosure, after the corresponding target DMRS port used for transmitting the PT-RS at each transmission occasion is determined, when each transmission occasion is reached, the PT-RS port will be mapped to the corresponding target DMRS port to transmit the PT-RS, thus achieving alternate mapping.

It should be noted that, in one example of the disclosure, the PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, at two adjacent transmission occasions, the PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” is avoided, the PT-RS transmission precision is ensured, the accuracy of phase noise estimation is ensured, and the problem of inaccurate phase noise estimation caused by channel changes and estimation delay is solved.

FIG. 5 is a schematic flow diagram of a method for transmitting information provided by another example of the disclosure. The method is performed by UE, and as shown in FIG. 5, the information transmission method may include the following steps:

Step 501, UE capability information is sent to a base station, the UE capability information being used for indicating whether the UE has a sending capability supporting PT-RS alternate mapping.

In one example of the disclosure, PT-RS alternate mapping means that: PT-RS ports of the UE may be alternately mapped to different DMRS ports at different transmission occasions. For example, at a first transmission occasion, a PT-RS port 0 may be mapped to a DMRS port 0; at a second transmission occasion, the PT-RS port 0 may be mapped to a DMRS port 1; and at a third transmission occasion, the PT-RS port 0 may be mapped to a DMRS port 3.

In one example of the disclosure, when the UE has the sending capability supporting PT-RS alternate mapping, this subsequent step that “a corresponding target DMRS port used for transmitting a PT-RS at each transmission occasion is determined” may be executed.

Step 502, an alternate mapping configuration instruction sent by the base station is obtained when the UE capability information sent by the UE to the base station indicates that the UE has the sending capability supporting PT-RS alternate mapping, the alternate mapping configuration instruction being used for indicating the UE to transmit the PT-RS according to PT-RS alternate mapping.

In one example of the disclosure, when the UE capability information sent by the UE to the base station indicates that the UE has the sending capability supporting PT-RS alternate mapping, the base station may send the alternate mapping configuration instruction to the UE, such that the UE may execute the next step that “the target DMRS port used for transmitting the PT-RS corresponding each subsequent transmission occasion is determined” according to the alternate mapping configuration instruction.

In another example of the disclosure, when the UE capability information sent by the UE to the base station indicates that the UE has the sending capability supporting PT-RS alternate mapping, the base station may also not send the alternate mapping configuration instruction to the UE, and at the moment, the UE may determine a target DMRS port configured by the base station in next step 504 as the target DMRS port for transmitting the PT-RS corresponding each subsequent transmission occasion.

Step 503, the UE obtains a port selecting rule and/or an alternate mapping parameter K configured by the base station, the port selecting rule being: defining a priority of channel quality of a channel corresponding to a DMRS port according to a possible quality distribution probability of a data layer, and selecting a target DMRS port according to the priority.

In one example of the disclosure, the base station may configure the port selecting rule and/or the alternate mapping parameter K to the UE. It should be noted that, in one example of the disclosure, when the base station does not configure the port selecting rule, the UE may determine the target DMRS port according to a predefined port selecting rule. In another example of the disclosure, when the base station does not configure the alternate mapping parameter K, the UE may determine the target DMRS port according to a predefined alternate mapping parameter K.

In one example of the disclosure, the alternate mapping parameter K is used for indicating the number of alternate mapping DMRS ports supported by the UE on a PT-RS port, K is a positive integer, and 2≤K≤the number of the DMRS ports in the DMRS port group associated with the PT-RS port.

For example, when the alternate mapping parameter K corresponding to the PT-RS port is 2, it shows that the PT-RS port supports alternate mapping in two DMRS ports. Thus, the UE may select two DMRS ports in the PT-RS port according to the port selecting rule to use the two DMRS ports as the corresponding target DMRS ports used for transmitting the PT-RS at each subsequent transmission occasion, and it should be ensured that the target DMRS ports corresponding to two adjacent transmission occasions are different.

It should be noted that, in the example of the disclosure, one PT-RS port corresponds to one alternate mapping parameter K. Moreover, in one example of the disclosure, the alternate mapping parameters K corresponding to different PT-RS ports may be the same. In another example of the disclosure, the alternate mapping parameters K corresponding to different PT-RS ports may be different.

In one example of the disclosure, the alternate mapping parameter K may be equal to the number of the DMRS port groups associated with the PT-RS ports. In another example of the disclosure, the alternate mapping parameter K may be less than the number of the DMRS port groups associated with the PT-RS ports.

In one example of the disclosure, a method for the base station to configure the alternate mapping parameter K may include: directly determining, by the base station, the alternate mapping parameter.

In another example of the disclosure, the method for the base station to configure the alternate mapping parameter K may include: transmitting, by the UE to the base station, an alternate mapping support parameter K1. The alternate mapping support parameter K1 is used for indicating the number of alternate mapping DMRS ports supported by the UE on each PT-RS port, K1 is a positive integer, and 2≤K1≤the number of the DMRS ports in the DMRS port group associated with the PT-RS port. The base station determines the alternate mapping parameter K according to the alternate mapping support parameter K1, where K≤K1, and configures the determined alternate mapping parameter K to the UE.

The port selecting rule may include: defining a priority of channel quality of a channel corresponding to a DMRS port according to a possible quality distribution probability of a data layer, and selecting the target DMRS port according to the priority. For example, first K DMRS ports with the channel quality of corresponding channels in the DMRS port group defined according to the possible quality distribution probability of the data layer ranked from high to low may be determined as the target DMRS ports.

Step 504, the target DMRS port associated with uplink PT-RS transmission is obtained. The target DMRS port is used for PT-RS transmission of a PUSCH at a first transmission occasion.

In one example of the disclosure, detailed introduction of this step may refer to step 101, which is not repeated here in the present example.

In one example of the disclosure, the base station may determine the target DMRS port associated with uplink PT-RS transmission from the DMRS port group associated with the PT-RS ports according to the port selecting rule configured by the base station for the UE. In one example of the disclosure, the DMRS port groups associated with the PT-RS ports may be configured by the base station through high-layer signaling.

Specifically, it can be seen from step 503 that, the port selecting rule configured by the base station is: defining a priority of channel quality of channels corresponding to DMRS ports according to a possible quality distribution probability of a data layer, and selecting the target DMRS port according to the priority. Based on this, in one example of the disclosure, a method for the base station to configure the target DMRS port associated with uplink PT-RS transmission according to the port selecting rule may include: determining a DMRS port with the highest channel quality in the DMRS port group associated with the PT-RS ports as the target DMRS port.

Step 505, the UE determines the target DMRS port used for transmitting the PT-RS corresponding each subsequent transmission occasion according to the alternate mapping configuration instruction and according to the predefined port selecting rule and the alternate mapping parameter K.

In another example of the disclosure, the UE may include a single PT-RS port. In another example of the disclosure, the UE may include a plurality of PT-RS ports.

In one example of the disclosure, when the UE includes the single PT-RS port, the single PT-RS port is associated with a group of DMRS ports scheduled and assigned for the UE. A method for determining the corresponding target DMRS port used for transmitting the PT-RS at each subsequent transmission occasion may be that: as for the single PT-RS port, the corresponding target DMRS port at each subsequent transmission occasion is determined from the associated DMRS port group according to the port selecting rule and the alternate mapping parameter K.

In another example of the disclosure, when the UE includes the plurality of PT-RS ports, each PT-RS port is associated with one DMRS port group. The DMRS port group associated with each PT-RS port is configured by the base station through high-layer signaling. Each PT-RS port corresponds to an alternate mapping parameter K. A method for determining the corresponding target DMRS port used for transmitting the PT-RS at each subsequent transmission occasion may be that: as for each PT-RS port used for transmitting the PT-RS, the target DMRS port corresponding each subsequent transmission occasion is correspondingly determined from the associated DMRS port group according to the port selecting rule and the alternate mapping parameter K.

Further, in the example of the disclosure, the UE determining the corresponding target DMRS port at each subsequent transmission occasion from the associated DMRS port group according to the port selecting rule and the alternate mapping parameter K, may include:

K target DMRS ports from the associated DMRS port group according to the port selecting rule and the alternate mapping parameter K is determined, and then the K target DMRS ports as the corresponding target DMRS ports used for transmitting the PT-RS at each subsequent transmission occasion respectively is determined.

For example, assuming that the UE merely includes the PT-RS port 0, a DMRS port group corresponding to the PT-RS port 0 is: a DMRS port 0, a DMRS port 1, a DMRS port 2 and a DMRS port 3. The UE will repeatedly transmit the PT-RS by using a first transmission occasion, a second transmission occasion, a third transmission occasion and a fourth transmission occasion respectively. The target DMRS port configured by the base station obtained by the UE through step 504 above is the DMRS port 2, the alternate mapping parameter K determined by the UE through step 503 above is 2, and the port selecting rule is: defining a priority of channel quality of a channel corresponding to a DMRS port according to a possible quality distribution probability of a data layer, and selecting the target DMRS port according to the priority.

In another example of the disclosure, in this step, a method for the UE to determine the corresponding target DMRS port used for transmitting the PT-RS at each subsequent transmission occasion according to the alternate mapping configuration instruction and according to the predefined port selecting rule and the alternate mapping parameter K may be that: a rank from high to low of the channel quality of channels corresponding to the DMRS port 0, the DMRS port 1, the DMRS port 2 and the DMRS port 3 at each transmission occasion is defined according to the possible quality distribution probability of the data layer, the first two DMRS ports with the channel quality of the channels corresponding to the DMRS port 0, the DMRS port 1, the DMRS port 2 and the DMRS port 3 at certain transmission occasion (i.e., the first transmission occasion, or the second transmission occasion, or the third transmission occasion or the fourth transmission occasion) from high to low are determined as the target DMRS ports, and alternate mapping is performed between the first two DMRS ports at subsequent transmission occasions.

For example, assuming that a rank from high to low of the channel quality of the channels corresponding to the DMRS port 0, the DMRS port 1, the DMRS port 2 and the DMRS port 3 at the second transmission occasion according to the possible quality distribution probability of the data layer is: DMRS port 0>DMRS port 1>DMRS port 2>DMRS port 3, then the DMRS port 0 and the DMRS port 1 may be determined as the target DMRS ports, and alternate mapping is performed between the DMRS port 0 and the DMRS port 1 at the subsequent transmission occasions, for example, at the second transmission occasion, the PT-RS port 0 is mapped to the DMRS port 0, at the third transmission occasion, the PT-RS port 0 is mapped to the DMRS port 1, and at the fourth transmission occasion, the PT-RS port 0 is mapped to the DMRS port 0.

Step 506, a PT-RS port is mapped to the corresponding target DMRS port at each transmission occasion for transmitting the PT-RS.

In one example of the disclosure, after the corresponding target DMRS port used for transmitting the PT-RS at each transmission occasion is determined, when each transmission occasion is reached, the PT-RS port will be mapped to the corresponding target DMRS port to transmit the PT-RS, thus achieving alternate mapping.

It should be noted that, in one example of the disclosure, the PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, at two adjacent transmission occasions, the PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” is avoided, the PT-RS transmission precision is ensured, the accuracy of phase noise estimation is ensured, and the problem of inaccurate phase noise estimation caused by channel changes and estimation delay is solved.

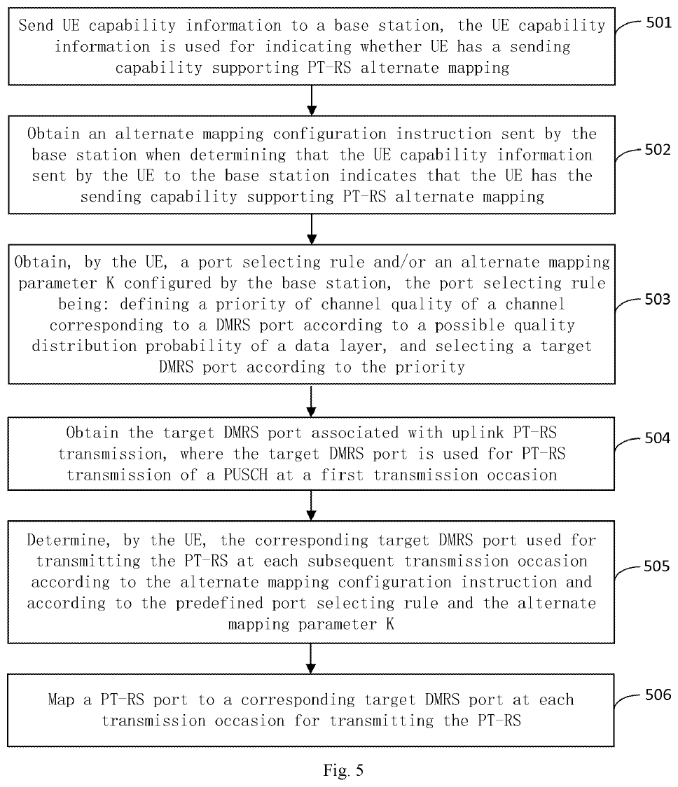

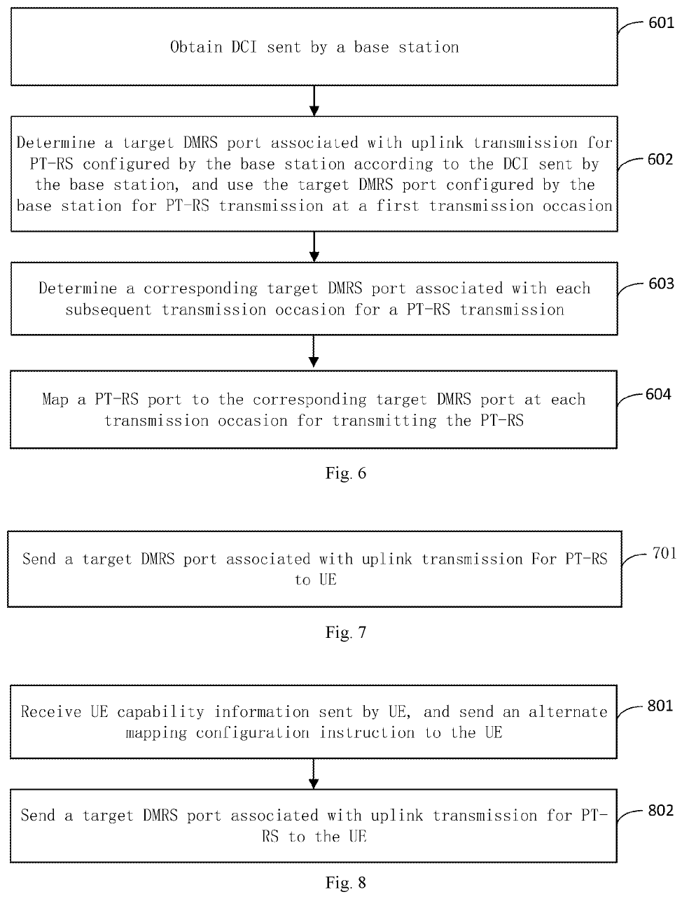

FIG. 6 is a schematic flow diagram of a method for transmitting information provided by another example of the disclosure. The method is performed by user equipment (UE), and as shown in FIG. 6, the information transmission method may include the following steps:

Step 601, DCI sent by a base station is obtained.

In one example of the disclosure, the DCI includes a target DMRS port associated with uplink PT-RS transmission configured by the base station, and the target DMRS port configured by the base station is used for PT-RS transmission at a first PUSCH transmission occasion.

Step 602, the target DMRS port associated with uplink PT-RS transmission configured by the base station is determined according to the DCI sent by the base station, and the target DMRS port configured by the base station is used for PT-RS transmission at the first transmission occasion.

In one example of the disclosure, the UE may obtain the target DMRS port associated with uplink PT-RS transmission configured by the base station according to the DCI sent by the base station. The DCI may include indication code points, the bit numbers of the indication code points correspond to the number of PT-RS port groups included in the UE, different bit numbers in the indication code points correspond to different PT-RS ports to be used for indicating DMRS ports corresponding to the corresponding PT-RS ports, and different code numbers in the indication code points are used for indicating target DMRS ports corresponding to the corresponding PT-RS ports.

For example, when the UE merely includes a PT-RS port 0, and the PT-RS port 0 corresponds to a DMRS port group scheduled by the UE, and maximally corresponds to a case of 4 uplink ports, including: a DMRS port 0, a DMRS port 1, a DMRS port 2 and a DMRS port 3. The indication code points merely correspond to an indication of one specific associated DMRS port, where a corresponding relationship between the indication code points and the DMRS ports may be as shown in Table 1.

TABLE 1

| Indication code point | DMRS port |
|---|---|
| 0 | DMRS port 0 |
| 1 | DMRS port 1 |
| 2 | DMRS port 2 |
| 3 | DMRS port 3 |

It can be seen from Table 1 that, when the indication code point in the DCI received by the UE is 0, it may be determined that the target DMRS port indicated by the base station is the DMRS port 0; and when the indication code point in the DCI received by the UE is 1, it may be determined that the target DMRS port indicated by the base station is the DMRS port 1.

It corresponds to a case of 2 PT-RS ports, the UE includes a PT-RS port 0 and a PT-RS port 1, the PT-RS port 0 correspondingly indicates a DMRS port group configured via high-layer signaling, including: a DMRS port 0 and a DMRS port 1, and the PT-RS port 1 corresponds to a DMRS associated group configured via high-layer signaling, including: a DMRS port 0 and a DMRS port 1. The indication code points may include two bits, where a high bit of the indication code points may be used for indicating the DMRS port corresponding to the PT-RS port 0, and a low bit of the indication code points may be used for indicating a DMRS port corresponding to the PT-RS port 1. A corresponding relationship between the indication code points and the DMRS ports may be as shown in Table 2 and Table 3.

TABLE 2

| High bit of indication code | |
|---|---|
| point | DMRS port |
| 0 | DMRS port 0 |
| 1 | DMRS port 1 |

TABLE 3

| Low bit of indication code | |
|---|---|
| point | DMRS port |
| 0 | DMRS port 0 |
| 1 | DMRS port 1 |

As shown in Table 2 and Table 3, when the indication code point received by the UE is 01, it may be determined that the high bit of the indication code point is 0 and the low bit is 1, and then it may be determined that the target DMRS port corresponding to the PT-RS port 0 indicated by the base station is the DMRS port 0, and the target DMRS port corresponding to the PT-RS port 1 is the DMRS port 1. When the indication code point received by the UE is 10, it may be determined that the high bit of the indication code point is 1 and the low bit is 0, and then it may be determined that the target DMRS port corresponding to the PT-RS port 0 indicated by the base station is the DMRS port 1, and the target DMRS port corresponding to the PT-RS port 1 is the DMRS port 0.

Thus, the UE may determine the target DMRS port indicated by the base station through the indication code points included in the DCI sent by the base station.

Step 603, a target DMRS port used for transmitting a PT-RS corresponding each subsequent transmission occasion is determined.

In one example of the disclosure, an execution method of this step may refer to steps 202-205, steps 302-305, steps 402-405 and steps 502-505 above, which is not repeated here in the example of the disclosure.

Step 604, a PT-RS port is mapped to the corresponding target DMRS port at each transmission occasion for transmitting the PT-RS.

In one example of the disclosure, after the target DMRS port used for transmitting the PT-RS corresponding each transmission occasion is determined, when each transmission occasion is reached, the PT-RS port will be mapped to the corresponding target DMRS port to transmit the PT-RS, thus achieving alternate mapping.

It should be noted that, in one example of the disclosure, the PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, at two adjacent transmission occasions, the PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

FIG. 7 is a schematic flow diagram of a method for transmitting information provided by another example of the disclosure. The method is performed by a base station, and as shown in FIG. 7, the information transmission method may include the following steps:

Step 701, a target DMRS port associated with uplink PT-RS transmission is sent to UE. The target DMRS port is used for PT-RS transmission of a PUSCH at a first transmission occasion.

In one example of the disclosure, detailed introduction of this step may refer to step 101, which is not repeated here in the present example.

It should be noted that, in one example of the disclosure, a PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, the target DMRS port configured by the base station is mainly used for PT-RS transmission of the PUSCH at the first transmission occasion, each subsequent transmission occasion may correspond to other DMRS ports, such that at two adjacent transmission occasions, a PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

FIG. 8 is a schematic flow diagram of a method for transmitting information provided by another example of the disclosure. The method is performed by a base station, and as shown in FIG. 8, the method for transmitting information may include the following steps:

Step 801, UE capability information sent by UE is received, and an alternate mapping configuration instruction is sent to the UE. The UE capability information is used for indicating whether the UE has a sending capability supporting PT-RS alternate mapping, and the alternate mapping configuration instruction is used for indicating the UE to transmit a PT-RS according to PT-RS alternate mapping.

In one example of the disclosure, when the UE capability information received by the base station indicates that the UE has the sending capability supporting PT-RS alternate mapping, the base station may send the alternate mapping configuration instruction to the UE, such that the UE may determine a corresponding target DMRS port used for transmitting the PT-RS at each subsequent transmission occasion according to the alternate mapping configuration instruction, and ensure that target DMRS ports corresponding to two adjacent transmission occasions are different.

In another example of the disclosure, when the UE capability information received by the base station indicates that the UE has the sending capability supporting PT-RS alternate mapping, the base station may not send the alternate mapping configuration instruction to the UE, such that the UE transmits the PT-RS at each transmission occasion according to a target DMRS port configured by the base station in next step 802.

Step 802, a target DMRS port associated with uplink PT-RS transmission is sent to the UE. The target DMRS port is used for PT-RS transmission of a PUSCH at a first transmission occasion.

In one example of the disclosure, detailed introduction of this step may refer to step 101, which is not repeated here in the present example.

It should be noted that, in one example of the disclosure, a PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, the target DMRS port configured by the base station is mainly used for PT-RS transmission of the PUSCH at the first transmission occasion, each subsequent transmission occasion may correspond to other DMRS ports, such that at two adjacent transmission occasions, a PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

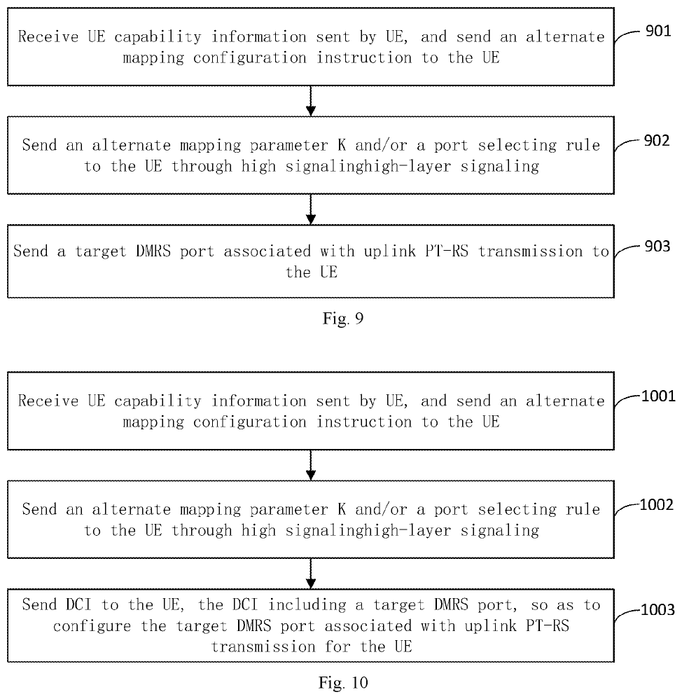

FIG. 9 is a schematic flow diagram of a method for transmitting information provided by another example of the disclosure. The method is performed by a base station, and as shown in FIG. 9, the information transmission method may include the following steps:

Step 901, UE capability information sent by UE is received, and an alternate mapping configuration instruction is sent to the UE. The UE capability information is used for indicating whether the UE has a sending capability supporting PT-RS alternate mapping, and the alternate mapping configuration instruction is used for indicating the UE to transmit a PT-RS according to PT-RS alternate mapping.

In one example of the disclosure, when the UE capability information received by the base station indicates that the UE has the sending capability supporting PT-RS alternate mapping, the base station may send the alternate mapping configuration instruction to the UE, such that the UE may determine a corresponding target DMRS port used for transmitting the PT-RS at each subsequent transmission occasion according to the alternate mapping configuration instruction, and ensure that target DMRS ports corresponding to two adjacent transmission occasions are different.

In another example of the disclosure, when the UE capability information received by the base station indicates that the UE has the sending capability supporting PT-RS alternate mapping, the base station may not send the alternate mapping configuration instruction to the UE, such that the UE transmits the PT-RS at each transmission occasion according to a target DMRS port configured by the base station in next step 903.

Step 902, an alternate mapping parameter K and/or a port selecting rule are/is sent to the UE through high-layer signaling.

In another example of the disclosure, the base station may configure the port selecting rule and/or the alternate mapping parameter K to the UE. It should be noted that, in one example of the disclosure, when the base station does not configure the port selecting rule, the UE may determine the target DMRS port according to a predefined port selecting rule. In another example of the disclosure, when the base station does not configure the alternate mapping parameter K, the UE may determine the target DMRS port according to a predefined alternate mapping parameter K.

In one example of the disclosure, the alternate mapping parameter K is used for indicating the number of alternate mapping DMRS ports supported by the UE on a PT-RS port, K is a positive integer, and 2≤K≤the number of the DMRS ports in the DMRS port group associated with the PT-RS port.

For example, when the alternate mapping parameter K corresponding to the PT-RS port is 2, it shows that the PT-RS port supports alternate mapping in two DMRS ports. Thus, the UE may select two DMRS ports in the PT-RS port according to the port selecting rule to use the two DMRS ports as the corresponding target DMRS ports used for transmitting the PT-RS at each subsequent transmission occasion, and it should be ensured that the target DMRS ports corresponding to two adjacent transmission occasions are different.

It should be noted that, in the example of the disclosure, one PT-RS port corresponds to one alternate mapping parameter K. Moreover, in one example of the disclosure, the alternate mapping parameters K corresponding to different PT-RS ports may be the same. In another example of the disclosure, the alternate mapping parameters K corresponding to different PT-RS ports may be different.

In one example of the disclosure, the alternate mapping parameter K may be equal to the number of the DMRS port groups associated with the PT-RS ports. In another example of the disclosure, the alternate mapping parameter K may be less than the number of the DMRS port groups associated with the PT-RS ports.

In one example of the disclosure, the port selecting rule may include: defining a priority of channel quality of a channel corresponding to a DMRS port according to a possible quality distribution probability of a data layer, and selecting the target DMRS port according to the priority. For example, first K DMRS ports with the channel quality of corresponding channels in the DMRS port group defined according to the possible quality distribution probability of the data layer ranked from high to low may be determined as the target DMRS ports. In another example of the disclosure, the port selecting rule may include: randomly selecting K DMRS ports in the DMRS port group as the target DMRS ports.

It should be noted that, in one example of the disclosure, step 901 and step 902 may also be executed as one step.

Step 903, a target DMRS port associated with uplink PT-RS transmission is sent to the UE. The target DMRS port is used for PT-RS transmission of a PUSCH at a first transmission occasion.

In one example of the disclosure, detailed introduction of this step may refer to step 101, which is not repeated here in the present example.

In one example of the disclosure, the base station may determine the target DMRS port associated with uplink PT-RS transmission from the DMRS port group associated with the PT-RS ports according to the port selecting rule configured by the base station for the UE. In one example of the disclosure, the DMRS port groups associated with the PT-RS ports may be configured by the base station through high-layer signaling.

It should be noted that, in one example of the disclosure, a PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, the target DMRS port configured by the base station is mainly used for PT-RS transmission of the PUSCH at the first transmission occasion, each subsequent transmission occasion may correspond to other DMRS ports, such that at two adjacent transmission occasions, a PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

FIG. 10 is a schematic flow diagram of a method for transmitting information provided by another example of the disclosure. The method is performed by a base station, and as shown in FIG. 10, the information transmission method may include the following steps:

Step 1001, UE capability information sent by UE is received, and an alternate mapping configuration instruction is sent to the UE. The UE capability information is used for indicating whether the UE has a sending capability supporting PT-RS alternate mapping.

In one example of the disclosure, when the UE capability information received by the base station indicates that the UE has the sending capability supporting PT-RS alternate mapping, the base station may send to the UE the alternate mapping configuration instruction which is used for indicating the UE to transmit a PT-RS according to PT-RS alternate mapping, such that the UE may determine a corresponding target DMRS port used for transmitting the PT-RS at each subsequent transmission occasion according to the alternate mapping configuration instruction, and ensure that target DMRS ports corresponding to two adjacent transmission occasions are different.

In another example of the disclosure, when the UE capability information received by the base station indicates that the UE has the sending capability supporting PT-RS alternate mapping, the base station may not send the alternate mapping configuration instruction to the UE, such that the UE transmits the PT-RS at each transmission occasion according to a target DMRS port configured by the base station in next step 1003.

Step 1002, an alternate mapping parameter K and/or a port selecting rule are/is sent to the UE through high-layer signaling.

In another example of the disclosure, the base station may configure the port selecting rule and/or the alternate mapping parameter K to the UE. It should be noted that, in one example of the disclosure, when the base station does not configure the port selecting rule, the UE may determine the target DMRS port according to a predefined port selecting rule. In another example of the disclosure, when the base station does not configure the alternate mapping parameter K, the UE may determine the target DMRS port according to a predefined alternate mapping parameter K.

In one example of the disclosure, the alternate mapping parameter K is used for indicating the number of alternate mapping DMRS ports supported by the UE on a PT-RS port, K is a positive integer, and 2≤K≤the number of the DMRS ports in the DMRS port group associated with the PT-RS port.

For example, when the alternate mapping parameter K corresponding to the PT-RS port is 2, it shows that the PT-RS port supports alternate mapping in two DMRS ports. Thus, the UE may select two DMRS ports in the PT-RS port according to the port selecting rule to use the two DMRS ports as the corresponding target DMRS ports used for transmitting the PT-RS at each subsequent transmission occasion, and it should be ensured that the target DMRS ports corresponding to two adjacent transmission occasions are different.

It should be noted that, in the example of the disclosure, one PT-RS port corresponds to one alternate mapping parameter K. Moreover, in one example of the disclosure, the alternate mapping parameters K corresponding to different PT-RS ports may be the same. In another example of the disclosure, the alternate mapping parameters K corresponding to different PT-RS ports may be different.

In one example of the disclosure, the alternate mapping parameter K may be equal to the number of the DMRS port groups associated with the PT-RS ports. In another example of the disclosure, the alternate mapping parameter K may be less than the number of the DMRS port groups associated with the PT-RS ports.

In one example of the disclosure, the port selecting rule may include: defining a priority of channel quality of a channel corresponding to a DMRS port according to a possible quality distribution probability of a data layer, and selecting the target DMRS port according to the priority. For example, first K DMRS ports with the channel quality of corresponding channels in the DMRS port group defined according to the possible quality distribution probability of the data layer ranked from high to low may be determined as the target DMRS ports. In another example of the disclosure, the port selecting rule may include: randomly selecting K DMRS ports in the DMRS port group as the target DMRS ports.

Step 1003, DCI is sent to the UE, the DCI including a target DMRS port, so as to configure the target DMRS port associated with uplink PT-RS transmission for the UE. The target DMRS port configured by the base station is used for PT-RS transmission of a PUSCH at a first transmission occasion.

In one example of the disclosure, detailed introduction of this step may refer to steps 601-602, which is not repeated here in the present example.

It should be noted that, in one example of the disclosure, a PT-RS is used for being repeatedly transmitted according to a scheduled PUSCH, and/or, in another example of the disclosure, the PT-RS is used for being repeatedly transmitted according to a non-scheduled PUSCH.

In the information transmission method provided by the example of the disclosure, when the PT-RS is repeatedly transmitted by using a multilayer transmission technology, the target DMRS port configured by the base station is mainly used for PT-RS transmission of the PUSCH at the first transmission occasion, each subsequent transmission occasion may correspond to other DMRS ports, such that at two adjacent transmission occasions, a PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

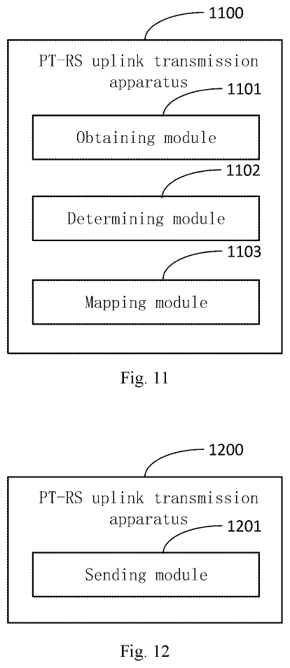

FIG. 11 is a schematic structural diagram of an apparatus for transmitting information provided by an example of the disclosure. As shown in FIG. 11, the apparatus 1100 may include:
an obtaining module 1101, configured to obtain a target demodulation reference signal (DMRS) port associated with uplink PT-RS transmission, where the target DMRS port is used for PT-RS transmission of a physical uplink shared channel (PUSCH) at a first transmission occasion;
a determining module 1102, configured to determine a corresponding target DMRS port used for transmitting a PT-RS at each subsequent transmission occasion, where one PT-RS port corresponds to one target DMRS port at each transmission occasion, the target DMRS port is included in a DMRS port group associated with the corresponding PT-RS port, and target DMRS ports corresponding to two adjacent transmission occasions are different; and
a mapping module 1103, configured to map the PT-RS port to a corresponding target DMRS port at each transmission occasion for transmitting the PT-RS.

In the information transmission apparatus provided by the example of the disclosure, when the PT-RS is repeatedly transmitted by using a multilayer transmission technology, the target DMRS port configured by a base station is mainly used for PT-RS transmission of the PUSCH at the first transmission occasion, each subsequent transmission occasion may correspond to other DMRS ports, such that at two adjacent transmission occasions, a PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

In one example of the disclosure, the apparatus 1100 is further configured to:
send UE capability information to the base station, the UE capability information being used for indicating whether UE has a sending capability supporting PT-RS alternate mapping;
obtain an alternate mapping configuration instruction sent by the base station when the UE capability information indicates that the UE has the sending capability supporting PT-RS alternate mapping, the alternate mapping configuration instruction being used for indicating the UE to transmit the PT-RS according to PT-RS alternate mapping; and
determine, by the UE, the corresponding target DMRS port used for transmitting the PT-RS at each subsequent transmission occasion according to the alternate mapping configuration instruction and according to a predefined port selecting rule and an alternate mapping parameter K, where the alternate mapping parameter K is used for indicating the number of alternate mapping DMRS ports supported by the UE on each PT-RS port, K is a positive integer, and 2≤K≤the number of the DMRS ports in the DMRS port group associated with the corresponding PT-RS port.

Further, in another example of the disclosure, the apparatus 1100 is further configured to:
send UE capability information to the base station, the UE capability information being used for indicating whether UE has a sending capability supporting PT-RS alternate mapping;
obtain an alternate mapping configuration instruction sent by the base station when the UE capability information indicates that the UE has the sending capability supporting PT-RS alternate mapping, the alternate mapping configuration instruction being used for indicating the UE to transmit the PT-RS according to PT-RS alternate mapping; at the same time, obtain an alternate mapping parameter K and/or a port selecting rule configured by the base station, where the alternate mapping parameter K is used for indicating the number of alternate mapping DMRS ports supported by the UE on each PT-RS port, K is a positive integer, and 2≤K≤the number of the DMRS ports in the DMRS port group associated with the corresponding PT-RS port; and
determine, by the UE, the corresponding target DMRS port used for transmitting the PT-RS at each subsequent transmission occasion according to the alternate mapping configuration instruction and according to the port selecting rule and the alternate mapping parameter K.

Further, in another example of the disclosure, the alternate mapping parameter K and/or the port selecting rule are/is configured by the base station through high-layer signaling.

Further, in another example of the disclosure, the UE includes a single PT-RS port, and the single PT-RS port is associated with a group of DMRS ports scheduled and assigned for the UE.

Further, in another example of the disclosure, the UE includes a plurality of PT-RS ports, and each PT-RS port is associated with one DMRS port group. The DMRS port group associated with each PT-RS port is configured by the base station through high-layer signaling; and
each PT-RS port corresponds to an alternate mapping parameter K that is predefined or is configured by the base station.

Further, in another example of the disclosure, the obtaining module 1101 is further configured to:
obtain downlink control information (DCI) sent by the base station, where the DCI includes the target DMRS port.

Further, in another example of the disclosure, the PT-RS is used for being repeatedly transmitted according to a scheduled PUSCH, and/or being repeatedly transmitted according to a non-scheduled PUSCH.

FIG. 12 is a schematic structural diagram of an apparatus for transmitting information provided by another example of the disclosure. As shown in FIG. 12, the apparatus 1200 may include:
a sending module 1201, configured to send a target DMRS port associated with uplink PT-RS transmission to UE, where the target DMRS port is used for PT-RS transmission of a PUSCH at a first transmission occasion.

In the information transmission apparatus provided by the example of the disclosure, when a PT-RS is repeatedly transmitted by using a multilayer transmission technology, the target DMRS port configured by a base station is mainly used for PT-RS transmission of the PUSCH at the first transmission occasion, each subsequent transmission occasion may correspond to other DMRS ports, such that at two adjacent transmission occasions, a PT-RS port will be mapped to different target DMRS ports, thus achieving alternate mapping of the DMRS ports during PT-RS transmission. In other words, at the adjacent transmission occasions, different channels will be adopted to transmit the PT-RS, then the phenomenon that “a fixed channel is adopted to transmit PT-RSs at various transmission occasions” may be avoided, the PT-RS transmission precision is ensured, the accuracy of phase noise estimation is ensured, and the problem of inaccurate phase noise estimation caused by channel changes and estimation delay is solved.

In one example of the disclosure, the apparatus 1200 is further configured to:
receive UE capability information sent by the UE, where the UE capability information is used for indicating whether the UE has a sending capability supporting PT-RS alternate mapping; and
send an alternate mapping configuration instruction to the UE when determining that the UE capability information received by the base station indicates that the UE has the sending capability supporting PT-RS alternate mapping, the alternate mapping configuration instruction being used for indicating the UE to transmit the PT-RS according to PT-RS alternate mapping.

Further, in another example of the disclosure, the apparatus 1200 is further configured to:
send an alternate mapping parameter K and/or a port selecting rule to the UE through high-layer signaling.

Further, in another example of the disclosure, the sending module 1201 is further configured to: send DCI to the UE, the DCI including the target DMRS port.

Further, in another example of the disclosure, the UE includes a single PT-RS port, and the single PT-RS port is associated with a group of DMRS ports scheduled and assigned for the UE.

Further, in another example of the disclosure, the UE includes a plurality of PT-RS ports, and each PT-RS port is associated with one DMRS port group. The DMRS port group associated with each PT-RS port is configured by the base station through high-layer signaling; and
each PT-RS port corresponds to an alternate mapping parameter K that is predefined or is configured by the base station.

To implement the above examples, the disclosure further provides a computer storage medium.

The computer storage medium provided by the example of the disclosure stores an executable program. The executable program, after being executed by a processor, can implement a determining method of the information transmission method shown in any one of FIG. 1-6 or 7-10.

To implement the above examples, the disclosure further provides a computer program product, including a computer program. The computer program, when executed by a processor, implements a determining method of the information transmission method shown in any one of FIG. 1-6 or 7-10.

In addition, to implement the above examples, the disclosure further provides a computer program. The program, when executed by a processor, implements the method for transmitting information shown in any one of FIG. 1-6 or 7-10.

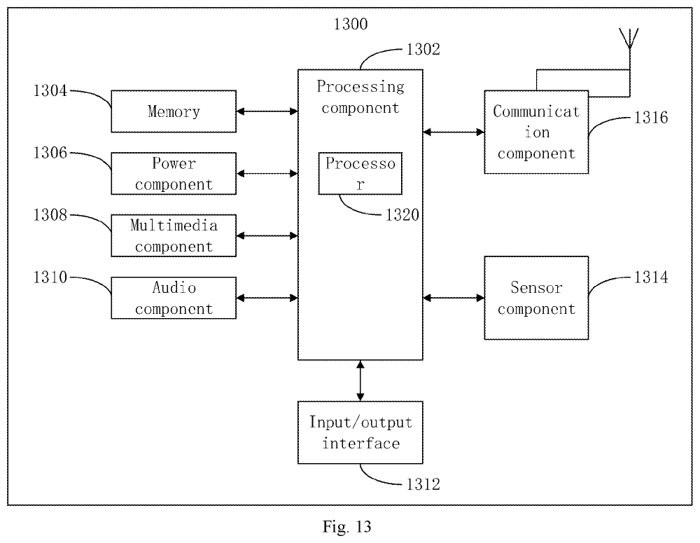

FIG. 13 is a block diagram of user equipment (UE) 1300 provided by an example of the disclosure. For example, the UE 1300 may be a mobile phone, a computer, digital broadcasting user equipment, a messaging device, a game console, a tablet device, a medical device, a fitness device, a personal digital assistant, etc.

Referring to FIG. 13, the UE 1300 may include at least one of the following components: a processing component 1302, a memory 1304, a power component 1306, a multimedia component 1308, an audio component 1310, an input/output (I/O) interface 1312, a sensor component 1314, and a communication component 1316.

The processing component 1302 typically controls the overall operation of the UE 1300, such as operations associated with display, telephone call, data communication, camera operations, and recording operations. The processing component 1302 may include at least one processor 1320 to execute instructions to complete all or part of the steps of the above method. In addition, the processing component 1302 may include at least one module to facilitate interaction between the processing component 1302 and other components. For example, the processing component 1302 may include a multimedia module to facilitate interaction between the multimedia component 1308 and the processing component 1302.

The memory 1304 is configured to store various types of data to support operations at the UE 1300. Instances of these data include instructions for any application or method operating on the UE 1300, contact data, phone book data, messages, pictures, videos, etc. The memory 1304 may be implemented by any type of volatile or nonvolatile storage device or a combination of them, such as a static random access memory (SRAM), an electrically erasable programmable read only memory (EEPROM), an erasable programmable read only memory (EPROM), a programmable read only memory (PROM), a read only memory (ROM), a magnetic memory, a flash memory, a magnetic disk or an optical disk.

The power component 1306 provides power for various components of the UE 1300. The power component 1306 may include a power management system, at least one power source and other components associated with generating, managing and distributing power for the UE 1300.

The multimedia component 1308 includes a screen providing an output interface between the UE 1300 and a user. In some examples, the screen may include a liquid crystal display (LCD) and a touch panel (TP). If the screen includes the touch panel, the screen may be implemented as a touch screen to receive an input signal from the user. The touch panel includes at least one touch sensor to sense touch, sliding and gestures on the touch panel. The touch sensor can not only sense the boundary of the touch or sliding operation, but also detect the awakening time and pressure related to the touch or sliding operation. In some examples, the multimedia component 1308 includes a front camera and/or a rear camera. When the UE 1300 is in an operation mode, such as a shooting mode or a video mode, the front camera and/or the rear camera can receive external multimedia data. Each front camera and rear camera can be a fixed optical lens system or have a focal length and optical zoom capability.

The audio component 1310 is configured to output and/or input audio signals. For example, the audio component 1310 includes a microphone (MIC) configured to receive an external audio signal when the UE 1300 is in the operation mode, such as a call mode, a recording mode, and a speech recognition mode. The received audio signal may be further stored in the memory 1304 or transmitted via the communication component 1316. In some examples, the audio component 1310 also includes a speaker for outputting an audio signal.

The I/O interface 1312 provides an interface between the processing component 1302 and a peripheral interface module which can be a keyboard, a click wheel, a button, etc. These buttons may include but are not limited to: a home button, volume buttons, a start button and a lock button.

The sensor component 1314 includes at least one sensor for providing state evaluation in various aspects for the UE 1300. For example, the sensor component 1314 can detect an on/off state of the UE 1300 and the relative positioning of the components, for example, the component is a display and a keypad of the UE 1300. The sensor component 1314 can also detect the change of the position of the UE 1300 or one component of the UE 1300, the presence or absence of user contact with the UE 1300, the azimuth or acceleration/deceleration of the UE 1300, and temperature change of the UE 1300. The sensor component 1314 may include a proximity sensor configured to detect the presence of nearby objects without any physical contact. The sensor component 1314 may further include an optical sensor, such as a CMOS or CCD image sensor, for use in imaging applications. In some examples, the sensor component 1314 may further include an acceleration sensor, a gyroscope sensor, a magnetic sensor, a pressure sensor, or a temperature sensor.

The communication component 1316 is configured to facilitate wired or wireless communication between the UE 1300 and other devices. The UE 1300 may access a wireless network based on a communication standard, such as WiFi, 2G or 3G, or a combination of them. In an example, the communication component 1316 receives a broadcast signal or broadcast-related information from an external broadcast management system via a broadcast channel. In an example, the communication component 1316 further includes a near field communication (NFC) module to facilitate short-range communication. For example, the NFC module may be implemented based on radio frequency identification (RFID) technology, infrared data association (IrDA) technology, ultra wideband (UWB) technology, Bluetooth (BT) technology and other technologies.

In an example, the UE 1300 may be implemented by at least one application-specific integrated circuit (ASIC), digital signal processor (DSP), digital signal processing device (DSPD), programmable logic device (PLD), field programmable gate array (FPGA), controller, microcontroller, microprocessor, or other electronic elements for performing the above method.

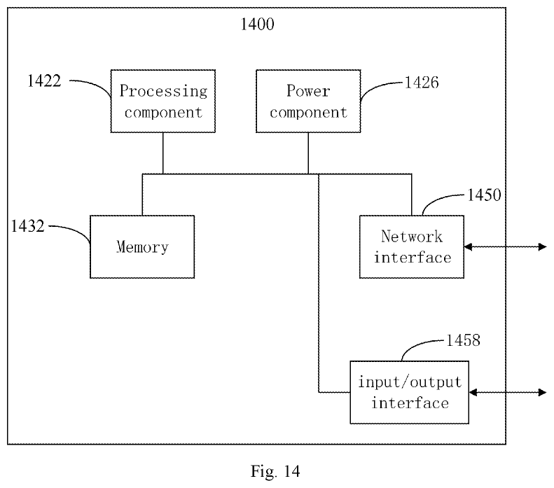

FIG. 14 is a schematic structural diagram of a base station 1400 provided by an example of the present application. For example, the base station 1400 may be provided as a base station. Referring to FIG. 14, the base station 1400 includes a processing component 1422, which further includes at least one processor, and a memory resource represented by a memory 1432 for storing instructions, such as applications, that can be executed by the processing component 1422. The applications stored in the memory 1432 may include one or more modules each corresponding to a set of instructions. In addition, the processing component 1422 is configured to execute instructions to execute any method performed by the base station above, such as the method shown in any one of FIGS. 6-10.

The base station 1400 may further include a power component 1426 configured to perform power management of the base station 1400, a wired or wireless network interface 1450 configured to connect the base station 1400 to the network, and an input/output (I/O) interface 1458. The base station 1400 can operate an operating system based on the memory 1432, such as Windows Server™, Mac OS X™, Unix™, Linux™, FreeBSD™, or the like.

Other implementation solutions of the disclosure will be apparent to those skilled in the art from consideration of the specification and practice of the disclosure here. The disclosure is intended to cover any variations, uses, or adaptations of the disclosure following the general principles of the disclosure and including such departures from the disclosure as come within known or customary practice in the art. It is intended that the specification and examples be considered as exemplary merely, with a true scope and spirit of the disclosure being indicated by the following claims.

It will be appreciated that the disclosure is not limited to the exact construction that has been described above and illustrated in the accompanying drawings, and that various modifications and changes may be made without departing from the scope of the disclosure. It is intended that the scope of the disclosure is merely limited by the appended claims.

1. A method for transmitting information, performed by user equipment (UE), and comprising:
obtaining a target demodulation reference signal (DMRS) port associated with uplink transmission for phase-tracking reference signal (PT-RS), wherein the target DMRS port is used for PT-RS transmission at a first transmission occasion of a physical uplink shared channel (PUSCH);
determining a target DMRS port associated with each subsequent transmission occasion for a PT-RS transmission, wherein one PT-RS port corresponds to one target DMRS port at each transmission occasion, the target DMRS port is comprised in a DMRS port group associated with the corresponding PT-RS port, and target DMRS ports corresponding to two adjacent transmission occasions are different; and
mapping a PT-RS port to a corresponding target DMRS port at each transmission occasion for the PT-RS transmission.

2. The method according to claim 1, further comprising:
sending UE capability information to a base station, wherein the UE capability information is used for indicating whether the UE has a sending capability supporting PT-RS alternate mapping;
obtaining an alternate mapping configuration instruction sent by the base station when the UE capability information indicates that the UE has the sending capability supporting PT-RS alternate mapping, wherein the alternate mapping configuration instruction is used for indicating the UE to transmit the PT-RS according to PT-RS alternate mapping; and
determining, by the UE, the corresponding target DMRS port used for transmitting the PT-RS at each subsequent transmission occasion according to the alternate mapping configuration instruction and according to a predefined port selecting rule and an alternate mapping parameter K, wherein the alternate mapping parameter K is used for indicating a number of alternate mapping DMRS ports supported by the UE on each PT-RS port, K is a positive integer, and 2≤K≤a number of DMRS ports in the DMRS port group associated with the corresponding PT-RS port.

3. The method according to claim 1, further comprising:
sending UE capability information to a base station, wherein the UE capability information is used for indicating whether the UE has a sending capability supporting PT-RS alternate mapping;
obtaining an alternate mapping configuration instruction sent by the base station when the UE capability information indicates that the UE has the sending capability supporting PT-RS alternate mapping, the alternate mapping configuration instruction being used for indicating the UE to transmit the PT-RS according to PT-RS alternate mapping; at the same time, obtaining an alternate mapping parameter K and/or a port selecting rule configured by the base station, wherein the alternate mapping parameter K is used for indicating a number of alternate mapping DMRS ports supported by the UE on each PT-RS port, K is a positive integer, and 2≤K≤a number of DMRS ports in the DMRS port group associated with the corresponding PT-RS port; and
determining, by the UE, the corresponding target DMRS port used for transmitting the PT-RS at each subsequent transmission occasion according to the alternate mapping configuration instruction and according to the port selecting rule and the alternate mapping parameter K.

4. The method according to claim 3, wherein the alternate mapping parameter K and/or the port selecting rule are/is configured by the base station through high-layer signaling.

5. The method according to claim 2, wherein the UE comprises a single PT-RS port, and the PT-RS port is associated with a group of DMRS ports scheduled and assigned for the UE.

6. The method according to claim 2, wherein the UE comprises a plurality of PT-RS ports, and each PT-RS port is associated with one DMRS port group, wherein the DMRS port group associated with each PT-RS port is configured by the base station through high-layer signaling; and
each PT-RS port corresponds to the alternate mapping parameter K that is predefined or is configured by the base station.

7. The method according to claim 1, wherein obtaining the target DMRS port associated with uplink PT-RS transmission comprises:
obtaining downlink control information (DCI) sent by a base station, wherein the DCI comprises the target DMRS port.

8. The method according to claim 1, wherein the PT-RS is used for repeated transmission based on a scheduled PUSCH and/or repeated transmission based on a non-scheduled PUSCH.

9. A method for transmitting information, performed by a base station, and comprising:
sending a target DMRS port associated with uplink transmission for phase-tracking reference signal (PT-RS) to UE, wherein the target DMRS port is used for PT-RS transmission of a PUSCH at a first transmission occasion.

10. The method according to claim 9, further comprising:
receiving UE capability information sent by the UE, wherein the UE capability information is used for indicating whether the UE has a sending capability supporting PT-RS alternate mapping; and
sending an alternate mapping configuration instruction to the UE when the UE capability information received by the base station indicates that the UE has the sending capability supporting PT-RS alternate mapping, wherein the alternate mapping configuration instruction is used for indicating the UE to transmit the PT-RS according to PT-RS alternate mapping.

11. The method according to claim 10, further comprising:
sending an alternate mapping parameter K and/or a port selecting rule to the UE through high-layer signaling.

12. The method according to claim 9, wherein sending the target DMRS port associated with uplink transmission for PT-RS to the UE comprises:
sending DCI to the UE, wherein the DCI comprises the target DMRS port.

13. The method according to claim 9, wherein the UE comprises a single PT-RS port, and the PT-RS port is associated with a group of DMRS ports scheduled and assigned for the UE.

14. The method according to claim 9, wherein the UE comprises a plurality of PT-RS ports, and each PT-RS port is associated with a DMRS port group, wherein the DMRS port group associated with each PT-RS port is configured by the base station through high-layer signaling; and
each PT-RS port corresponds to an alternate mapping parameter K that is predefined or is configured by the base station.

15. (canceled)

16. (canceled)

17. User equipment (UE), comprising: a transceiver; a memory; and a processor, connected with the transceiver and the memory and configured to control wireless signal transceiving of the transceiver and execute computer-executable instructions stored in the memory to implement:
obtain a target demodulation reference signal (DMRS) port associated with uplink transmission for phase-tracking reference signal (PT-RS), wherein the target DMRS port is used for PT-RS transmission at a first transmission occasion of a physical uplink shared channel (PUSCH);
determine a target DMRS port associated with each subsequent transmission occasion for a PT-RS transmission, wherein one PT-RS port corresponds to one target DMRS port at each transmission occasion, the target DMRS port is comprised in a DMRS port group associated with the corresponding PT-RS port, and target DMRS ports corresponding to two adjacent transmission occasions are different; and
mapping a PT-RS port to a corresponding target DMRS port at each transmission occasion for the PT-RS transmission.

18. A base station, comprising: a transceiver; a memory; and a processor, connected with the transceiver and the memory, configured to control wireless signal transceiving of the transceiver and execute computer-executable instructions stored in the memory to implement the method according to 9.

19. A computer storage medium, storing computer-executable instructions, wherein the computer-executable instructions are executed by a processor to implement the method according to claim 1.

20. The UE according to claim 17, wherein the processor is further configured to execute the computer-executable instructions stored in the memory to implement:
send UE capability information to a base station, wherein the UE capability information is used for indicating whether the UE has a sending capability supporting PT-RS alternate mapping;
obtain an alternate mapping configuration instruction sent by the base station when the UE capability information indicates that the UE has the sending capability supporting PT-RS alternate mapping, wherein the alternate mapping configuration instruction is used for indicating the UE to transmit the PT-RS according to PT-RS alternate mapping; and
determine, by the UE, the corresponding target DMRS port used for transmitting the PT-RS at each subsequent transmission occasion according to the alternate mapping configuration instruction and according to a predefined port selecting rule and an alternate mapping parameter K, wherein the alternate mapping parameter K is used for indicating a number of alternate mapping DMRS ports supported by the UE on each PT-RS port, K is a positive integer, and 2≤K≤a number of DMRS ports in the DMRS port group associated with the corresponding PT-RS port.

21. The UE according to claim 17, wherein the processor is further configured to execute the computer-executable instructions stored in the memory to implement:
send UE capability information to a base station, wherein the UE capability information is used for indicating whether the UE has a sending capability supporting PT-RS alternate mapping;
obtain an alternate mapping configuration instruction sent by the base station when the UE capability information indicates that the UE has the sending capability supporting PT-RS alternate mapping, the alternate mapping configuration instruction being used for indicating the UE to transmit the PT-RS according to PT-RS alternate mapping; at the same time, obtaining an alternate mapping parameter K and/or a port selecting rule configured by the base station, wherein the alternate mapping parameter K is used for indicating a number of alternate mapping DMRS ports supported by the UE on each PT-RS port, K is a positive integer, and 2≤K≤a number of DMRS ports in the DMRS port group associated with the corresponding PT-RS port; and
determine, by the UE, the corresponding target DMRS port used for transmitting the PT-RS at each subsequent transmission occasion according to the alternate mapping configuration instruction and according to the port selecting rule and the alternate mapping parameter K.

22. The UE according to claim 21, wherein the alternate mapping parameter K and/or the port selecting rule are/is configured by the base station through high-layer signaling.
